(19) United States
(12) Patent Application Publication
(10) Pub. No.: US 2026/0309178 A1
(43) Pub. Date: Oct. 8, 2026

(54) QUICK-ATTACH MOUNTING BRACKET FOR SEATING SYSTEM

(71) Applicant: Hussey Seating Company, North Berwick, ME (US)

(72) Inventor: Ian O'Neill, York, ME (US)

(21) Appl. No.: 19/638,678

(22) Filed: Apr. 3, 2026

Related U.S. Application Data
(60) Provisional application No. 63/783,564, filed on Apr. 4, 2025.

(51) Int. Cl. F16B 12/32; A47C 11/00; E04H 3/12

(52) U.S. Cl. CPC F16B 12/32; A47C 11/00; E04H 3/12

(57) ABSTRACT

A mounting bracket includes a base having a first side wall and a second side wall spaced apart from the first side wall. An interior is formed at least partially between the first side wall and the second side wall. A first clip is connected to the base and configured to engage a first channel of a seating nose member. The first clip has a first finger extending in a first direction. A second clip is connected to the base and configured to engage a second channel of the seating nose member. The second clip has a second finger extending in a second direction opposite the first direction. An adjustment mechanism is connected to the base and the first clip. The first clip is moveable relative to the second clip via the adjustment mechanism to secure the base to the seating nose member.

### CROSS-REFERENCE TO RELATED APPLICATION

This application claims the benefit of U.S. Provisional Application No. 63/783,564, filed Apr. 4, 2025, the contents of which is incorporated herein by reference in its entirety.

### FIELD

The present disclosure relates to a bleacher seating system. More particularly, the present disclosure relates to a mounting bracket for a bleacher seating system.

### BACKGROUND

Telescopic or retractable seating systems, commonly referred to as bleachers, provide a degree of flexibility when employed in multi-purpose environments such as gymnasia. During practice periods, there is little need for ample seating as there are typically few spectators. However, during sporting competitions, assemblies, or concerts, accommodation for large groups is necessary. The provision of one discrete chair per person would require excessive manpower and time and storage of such chairs would be complex and space-intensive. Telescopic or retractable bleacher systems can be retracted when seating is not required and extended when an audience is expected.

Such seating systems can be provided with aisle rails to assist individuals in maintaining their balance as they mount or descend the seating system aisles. In fact, certain localities have codified requirements for the provision of aisle rails. With advances in telescopic seating systems, there exists a need to efficiently position and reconfigure seats, rails, and other accessories.

### SUMMARY

Certain implementations are directed to a mounting bracket configured to connect to a nose or tier of a bleacher seating system.

In certain configurations the mounting bracket has a movable clip for selectively engaging a nose or tier of a bleacher seating system.

In certain configurations the mounting bracket includes a lower clip for engaging a lower channel on a bleacher nose or tier and an upper clip for engaging an upper channel on the bleacher nose or tier. One of the clips can be moved relative to the other to releasably secure the mounting bracket to the bleacher nose or tier.

In certain configurations a mounting bracket includes a base having a first side wall and a second side wall spaced apart from the first side wall. An interior is formed at least partially between the first side wall and the second side wall. A first clip is connected to the base and configured to engage a first channel of a seating nose or tier member. The first clip has a first finger extending in a first direction. A second clip is connected to the base and configured to engage a second channel of the seating nose or tier member. The second clip has a second finger extending in a second direction opposite the first direction. An adjustment mechanism is connected to the base and the first clip. The first clip is moveable relative to the second clip via the adjustment mechanism to secure the base to the seating nose or tier member.

In certain configurations a mounting bracket includes a base, a first clip, and an adjustment mechanism. The base has a first side wall and a second side wall spaced apart from the first side wall. An interior volume is formed at least partially between the first side wall and the second side wall. The first side wall includes a first slot and the second side wall includes a second slot. The first clip is disposed between the first side wall and the second side wall. The first clip includes a first finger disposed outside of the interior volume, a first tab received within the first slot, and a second tab received within the second slot. The adjustment mechanism is connected between the base and the first clip. The movement of the adjustment mechanism can permit the first tab to move along the first slot and the second tab to move along the second slot to adjust a position of the first clip relative to the base.

In certain configurations a mounting bracket includes a base, a first clip, a second clip, and an adjustment mechanism. The base has an end wall, a first side wall, and a second side wall spaced apart from the first side wall. An interior volume is formed at least partially between the first side wall and the second side wall. The end wall has a substantially L-shape including a vertical portion and an upper section. The end wall includes a channel extending through a middle of the end wall. The first clip is connected to the base and can engage a first channel of a seating nose member. The first clip has a first finger that extends in a first direction. The first clip includes a cutout formed at a rear of a body of the first clip opposite to the first finger. The cutout is sized to accommodate a rotational element of the seat. The second clip is connected to the base and can engage a second channel of the seating nose member. The second clip has a second finger that extends in a second direction opposite the first direction. The second clip includes a protrusion that projects in a direction opposite to the second finger and is configured to engage the second channel. The adjustment mechanism is connected to the base and the first clip. The adjustment mechanism comprises a pair of threaded fasteners. The first clip is moveable relative to the second clip via the adjustment mechanism to secure the base to the seating nose member.

In certain configurations a mounting bracket includes an upper portion, a lower portion, and a support beam that extends between the upper and lower portions. The upper portion includes a first body having a pair of first side walls. Each first side wall includes a first slot, and a first clip is coupled between the pair of first side walls. The first clip includes projections received in the first slots. The projections of the first clip are smaller than a length of the first slots to permit the first clip to translate along the first slots. The lower portion includes a second body that has a pair of second side walls. Each second side wall includes a second slot, and a second clip is coupled between the pair of second side walls. The second clip includes projections received in the second slots. The upper portion can connect to a first channel and a second channel of a first nose member of the bleacher seating system. The lower portion can connect to a first channel and a second channel of a second nose member of the bleacher seating system spaced apart from the first nose member.

Certain implementations include a method for connecting a mounting bracket to a bleacher seating system. A mounting bracket is positioned adjacent a nose or tier member of a bleacher system. The mounting bracket has a first clip having a first finger, a second clip having a second finger, and an adjustment mechanism. The second finger is positioned within a lower groove of the nose or tier member. The mounting bracket is rotated about the second finger to move the first finger into an upper groove of the nose or tier member. The adjustment mechanism is operated to cause the first clip of the mounting bracket to move away from the second clip so that the first finger is held within the upper groove.

In certain implementations, connecting a mounting bracket to a bleacher seating system includes positioning the mounting bracket proximate to a channel of a nose or tier member of the bleacher system. The nose or tier member includes an overhang proximate to the channel. An adjustment mechanism is rotated in a first rotational direction to cause a first clip of the mounting bracket to move in a first translational direction until an upper end of a first finger of the first clip is positioned to pass beneath the overhang. The first finger is positioned within the channel. The adjustment mechanism is rotated in a second rotational direction opposite to the first rotational direction to cause the first clip to move in a second translational direction opposite the first translational direction until an upper end of a first finger of the first clip is more superior than a lower end of the overhang.

### BRIEF DESCRIPTION OF THE DRAWINGS

The drawings are for illustration purposes only and are not drawn to scale unless otherwise indicated. The drawings are not intended to limit the scope of the disclosure. Various aspects and advantageous features of the present disclosure will become more apparent to those of ordinary skill when described in the detailed description of preferred examples and reference to the accompanying drawings.

FIG. 1 is a perspective view of a mounting bracket coupled to a bleacher nose.

FIG. 2 is a perspective view of the mounting bracket of FIG. 1.

FIG. 3 is a side view of the mounting bracket of FIG. 2 in a first position.

FIG. 4 is a side view of the mounting bracket of FIG. 2 in a second position.

FIG. 5 is a rear view of the mounting bracket of FIG. 2.

FIG. 6 is a cross-sectional view of the mounting bracket of FIG. 2, viewed along section 6--6.

FIG. 7 is a perspective view of a base of the mounting bracket of FIG. 2.

FIG. 8 is a perspective view of a first clip of the mounting bracket of FIG. 2.

FIG. 9 is a top view of the first clip of FIG. 8.

FIG. 10 is a side view of the first clip of FIG. 8.

FIG. 11 is a perspective view of a second clip of the mounting bracket of FIG. 2.

FIG. 12 is a bottom view of the second clip of FIG. 11.

FIG. 13 is a side view of the second clip of FIG. 11.

FIG. 14 is a perspective view of an interior plate of the mounting bracket of FIG. 2.

FIG. 15 is a perspective view of a top plate of the mounting bracket of FIG. 2.

FIG. 16 is a cross-sectional view of FIG. 1, viewed along section 16--16 and illustrating the mounting bracket coupled to the bleacher nose in an installation position.

FIG. 17 is a cross-sectional view of FIG. 1, viewed along section 16--16 and illustrating the mounting bracket coupled to the bleacher nose in an engaged position.

FIG. 18 is a perspective view of a mounting bracket according to another example.

FIG. 19 is a side view of the mounting bracket of FIG. 18.

FIG. 20 is a front view of the mounting bracket of FIG. 18.

FIG. 21 is a cross-sectional view of the mounting bracket of FIG. 18, viewed along line 21--21.

FIG. 22 is a perspective view of a lower clip of the mounting bracket of FIG. 18.

FIG. 23 is a cross-sectional view of the bracket of FIG. 18, illustrating the mounting bracket coupled to the bleacher nose in an installation position.

FIG. 24 is a cross-sectional view of the bracket of FIG. 18, illustrating the mounting bracket coupled to the bleacher nose in an engaged position.

FIG. 25 is a perspective view of a mounting bracket coupling a seat to a bleacher nose.

FIG. 26 is a rear perspective view of the mounting bracket and the seat of FIG. 25.

FIG. 27 is a perspective view of the mounting bracket of FIG. 25.

FIG. 28 is a side view of the mounting bracket of FIG. 27.

FIG. 29 is a rear view of the mounting bracket of FIG. 27.

FIG. 30 is a cross-sectional view of the mounting bracket of FIG. 27, viewed along section 30--30.

FIG. 31 is a perspective view of a first clip of the mounting bracket of FIG. 27.

FIG. 32 is a perspective view of a second clip of the mounting bracket of FIG. 27.

FIG. 33 is a cross-sectional view of the mounting bracket and seat of FIG. 26, viewed along section 33--33.

FIG. 34 is a cross-sectional view of the mounting bracket and seat of FIG. 26, viewed along section 34--34.

FIG. 35 is a cross-sectional view of the mounting bracket and seat of FIG. 25, viewed along section 35--35.

FIG. 36 is a perspective view of a mounting bracket according to another example, where the bracket is connected between a first and second bleacher nose.

FIG. 37 is a perspective view of the mounting bracket of FIG. 36.

FIG. 38 is a side view of the mounting bracket of FIG. 37.

FIG. 39 is an upper perspective view of an upper portion of the bracket of FIG. 37.

FIG. 40 is a lower perspective view of the upper portion of the bracket of FIG. 37.

FIG. 41 is a front perspective view of a lower portion of the bracket of FIG. 37.

FIG. 42 is a rear perspective view of the lower portion of the bracket of FIG. 37.

FIG. 43 is a side view of the upper portion of the mounting bracket of FIG. 36 coupled to the first bleacher nose.

FIG. 44 is a side view of the lower portion of the mounting bracket of FIG. 36 coupled to the second bleacher nose.

### DETAILED DESCRIPTION

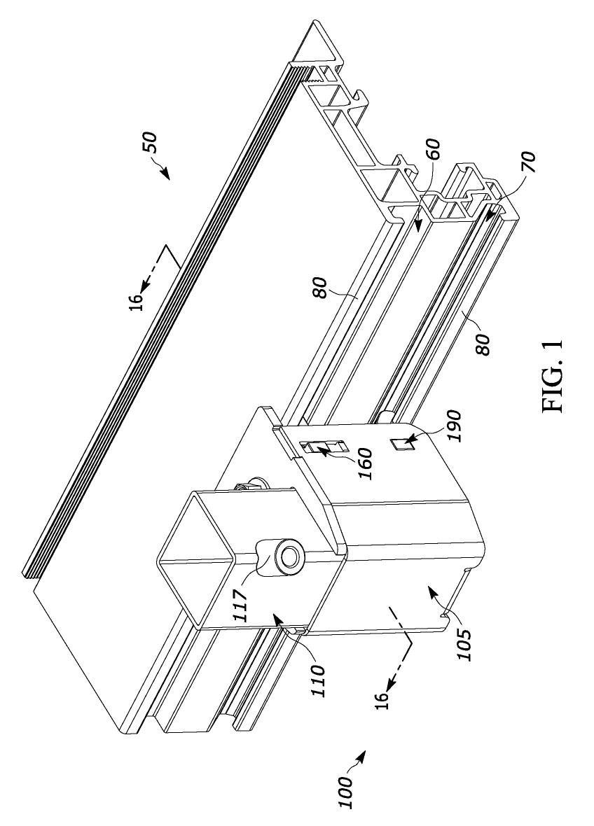

FIG. 1 illustrates a nose or tier 50 of a bleacher seating system. The nose 50 may be part of a tiered structure that can support a number of seating elements (not shown). For example, the nose 50 can be part of a telescopic or retractable seating system such as a bleacher system. The bleacher system can include multiple noses, with each nose having a respective front end or nose structure.

When the bleacher system is in an extended or open position, consecutive noses form a series of stepped platforms. A variety of seating features (not shown) may be provided, as known to one skilled in the art. Each nose has at least one respective step with consecutive noses having steps that are linearly aligned, such that the nose surfaces and the steps form a linear stairway. Such a stairway is also referred to as an aisle, in that various seating surfaces are typically arrayed along the nose front edges on one or both sides of the steps and each aisle enables users to mount or descend the noses and steps to reach or to leave seating in the bleacher system. When the bleacher system is in a retracted or closed position, the noses are substantially vertically aligned.

Translation between the closed position and the open position and between the open position and the closed position can be achieved either manually, by one or more users manually pushing or pulling on a portion of the bleacher system, or automatically, such as by actuation of a controller in communication with a drive motor.

The illustrated nose 50 may be constructed from a rigid material (e.g., metal, plastic, etc.) and may include an upper channel 60 and a lower channel 70 that is spaced apart from the upper channel 60. The upper and lower channels 60, 70 may each include a hook shape or otherwise J-channel configuration. For example, each channel 60, 70 may at least partially be defined by an overhang 80 disposed proximate to an opening of each channel 60, 70. Other configurations can also be used depending on the environment and application.

With continued reference to FIG. 1, a mounting bracket 100 may be selectively connected to the nose 50. As described in more detail below, the mounting bracket 100 may be connected to the nose 50 via direct engagement with the channels 60, 70. The mounting bracket 100 may support one or more different accessories that can be used with the bleacher seating system, including seats, rails, posts, and other features.

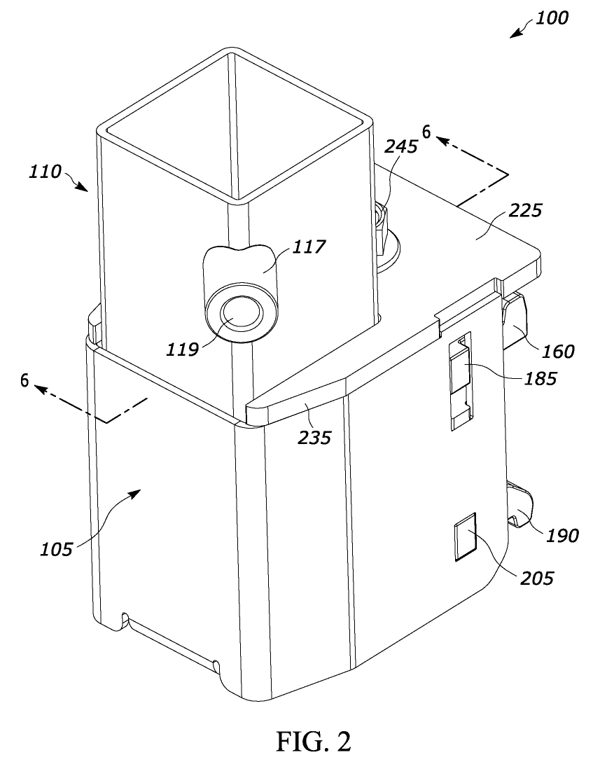

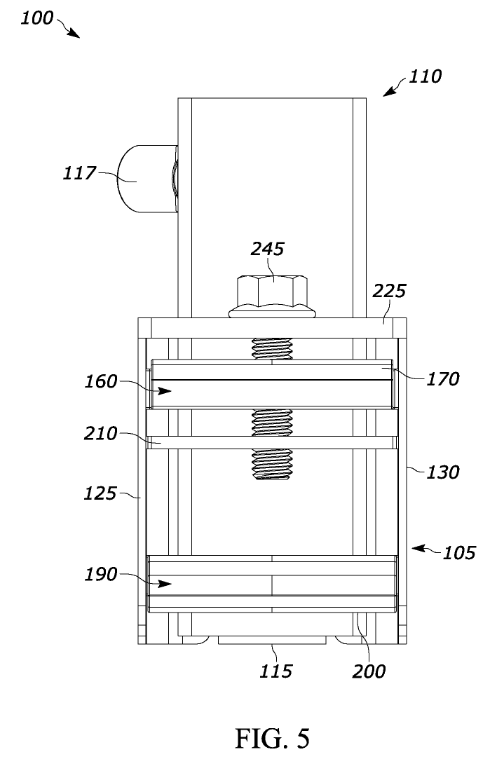

FIGS. 2 to 6 show an exemplary configuration of the mounting bracket 100 that includes a base 105. A first clip 160 is connected to the base 105 and a second clip 190 is connected to the base 105. At least one of the first clip 160 and second clip 190 can be moveable relative to the base 105 to secure the mounting bracket 100 to the nose 50. Movement can be caused by an adjustment mechanism 245, such as a threaded fastener, though other mechanisms may also be used. In some forms, an interior plate 210 and an upper plate 225 are also connected to the base 105.

In some forms, a receiver 110 is connected to the base 105. The receiver 110 may be fixed to the base 105. The receiver 110 may include a protrusion 117 that may be disposed proximate to an upper end of the receiver 110 (e.g., the protrusion 117 may be spaced apart from the base 105). The protrusion 117 may include an opening 119 (e.g., a threaded opening), which can receive an insert or fastener. As described in more detail below, the receiver 110 may support an accessory when the mounting bracket 100 is coupled to the nose 50.

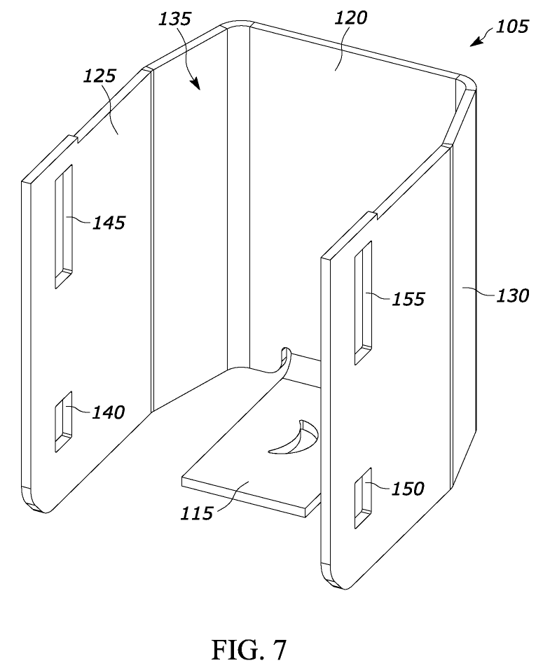

FIG. 7 shows an exemplary configuration of the base 105. The base 105 may include a bottom wall 115, an end wall 120, a first side wall 125, and a second side wall 130. In the illustrated example, the walls of the base 105 may be integrally formed in a one-piece construction. However, other examples of the base 105 may include one or more of the walls that are formed separately and connected with a mechanical fastener, adhesive, or through a joining process (e.g., welded) to the one or more adjacent walls.

In some forms, the end wall 120 may be connected to the bottom wall 115 in a substantially perpendicular orientation. The first and second side walls 125, 130 may be connected to either side of the end wall 120 in a substantially perpendicular orientation. In other examples, some of the walls may be positioned with a different angular orientation.

In certain forms, the bottom wall 115 may be smaller than the other walls of the base 105. For example, the bottom wall 115 may have a width that is less than the width of the end wall 120. The illustrated bottom wall 115 is therefore spaced apart from either or both of the side walls 125, 130. The bottom wall 115 may also have a length that is less than the length of the side walls 125, 130. For example, the bottom wall 115 may not extend to the outer edge of the side walls 125, 130.

In some forms, an interior volume 135 may be at least partially formed between the walls. The base 105 may be at least partially open and does not completely enclose the volume 135. However, other examples of the base 105 may include additional walls so that the interior volume 135 is enclosed.

In some forms, the first side wall 125 may include a first slot 140 and a second slot 145. The illustrated first and second slots 140, 145 may be disposed proximate to a free end of the first side wall 125 and may be aligned along an axis (e.g., an axis extending along a height direction of the first side wall 125). The second side wall 130 may similarly include a first slot 150 and a second slot 155. The first and second slots 150, 155 of the second side wall 130 may be respectively aligned with the first and second slots 140, 145 of the first side wall 125 across the width of the interior volume 135 such that the first slot 140 of the first side wall 125 is aligned with the first slot 150 of the second side wall 130 and the second slot 145 of the first side wall 125 is aligned with the second slot 155 of the second side wall 130.

In certain forms, each first slot 140, 150 may be disposed proximate to a lower edge of the respective side wall 125, 130 and may extend along a respective axis a first length. Each second slot 145, 155 may be disposed proximate to an upper edge of the respective side wall 125, 130 and may extend along the respective axis a second length that is greater than the first length. For example, each second slot 145, 155 may be at least twice as long as the respective first slot 140, 150.

In certain configurations the first slots 140, 150 are configured to receive the second clip 190 and the second slots are configured to receive the first clip 160 and the interior plate 210, although other arrangements can also be used.

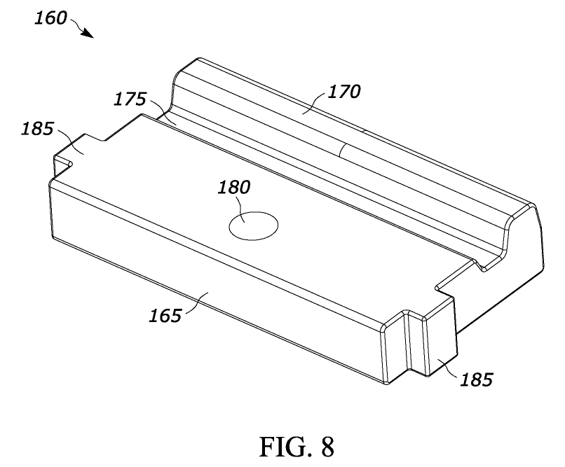

FIGS. 8 to 10 show an exemplary configuration of the first clip 160. The first clip 160 may include a body 165 and a first finger 170 that extends from the body 165. The body 165 may have a substantially rectangular shape, although other examples of the body 165 may include a different shape. The first finger 170 may extend from an end of the body 165 and may extend along substantially the entire length of the body 165. In other examples, the first finger 170 may extend along only a portion of the body 165 and/or the body 165 may include multiple fingers (e.g., two or more discontinuous fingers).

In some forms, a groove 175 may be disposed between the first finger 170 and a central region of the body 165. The groove 175 may form a thinner portion of the first clip 160. For example, a thickness of the body 165 may decrease toward the start of the first finger 170. The thickness of the first finger 170 may be the thickest portion of the first clip 160.

In some forms, the body 165 may include an opening 180. The fastener opening 180 may be disposed in a central region of the body 165. The opening 180 can be configured to receive the adjustment mechanism, for example a fastener. Other examples of the opening 180 may be disposed at other locations.

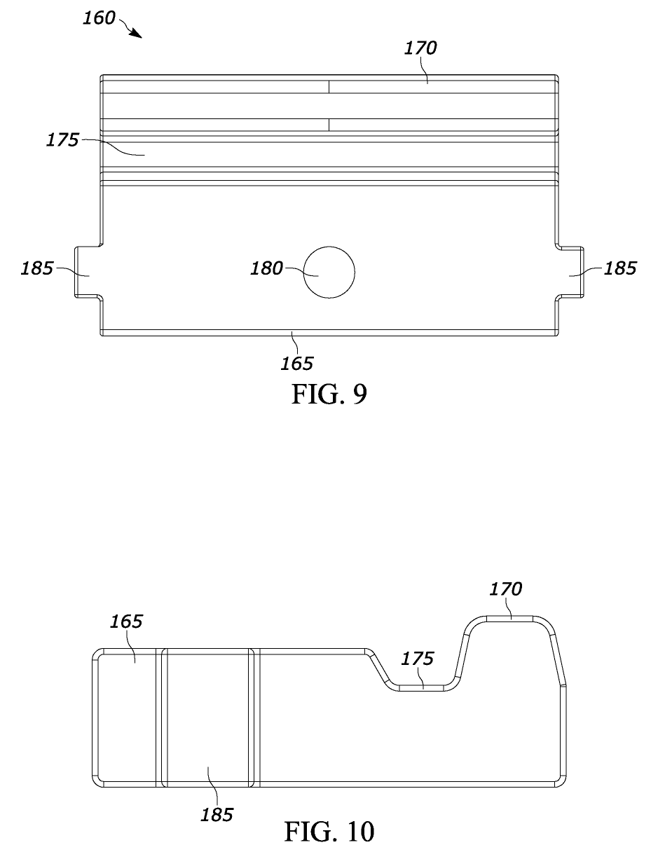

As best shown in FIGS. 8 and 9, two tabs 185 may extend from the body 165. In the illustrated example, one tab 185 may extend from either side edge of the body 165. For example, the tabs 185 may extend in a direction substantially perpendicular to the direction that the first finger 170 extends. In some forms, the tabs 185 may be aligned along an axis that extends across a width of the fastener opening 180. The tabs 185 may be received in the upper or second slots 145, 155 of the base 105.

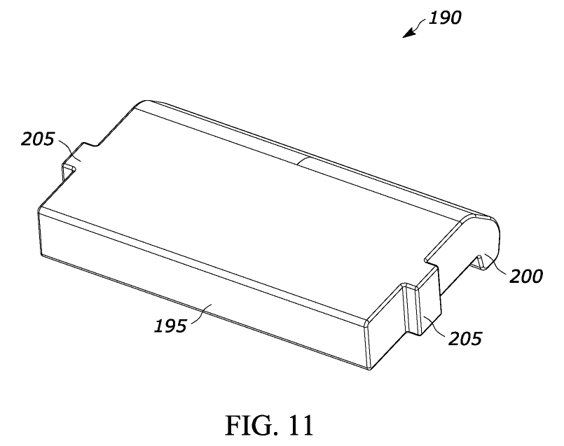

FIGS. 11 to 13 show an exemplary configuration of the second clip 190. The second clip 190 may include a body 195 and a second finger 200 that extends from the body 195. The body 195 may have a substantially rectangular shape, although other examples of the body 195 may include a different shape. In some forms, the body 195 may have a substantially similar shape as the body 165. The second finger 200 may extend from an end of the body 195 and may extend along substantially the entire length of the body 195. In other examples, the second finger 200 may extend along only a portion of the body 195 and/or the body 195 may include multiple fingers (e.g., two or more discontinuous fingers).

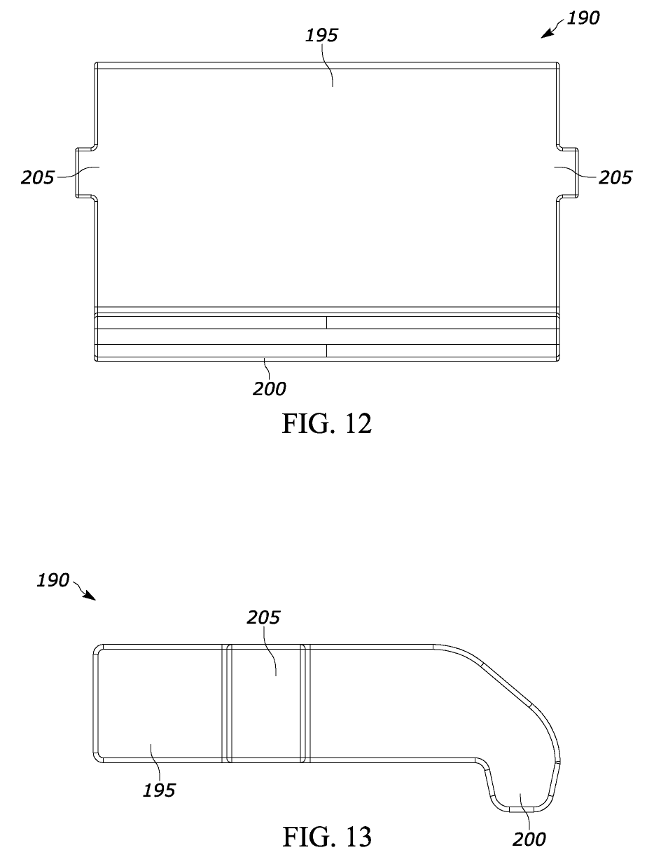

As best shown in FIGS. 11 and 12, two tabs 205 may extend from the body 195. In the illustrated example, one tab 205 may extend from either side edge of the body 195. For example, the tabs 205 may extend in a direction substantially perpendicular to the direction that the second finger 200 extends. The tabs 205 may be received in the lower or first slots 140, 150 of the base 105.

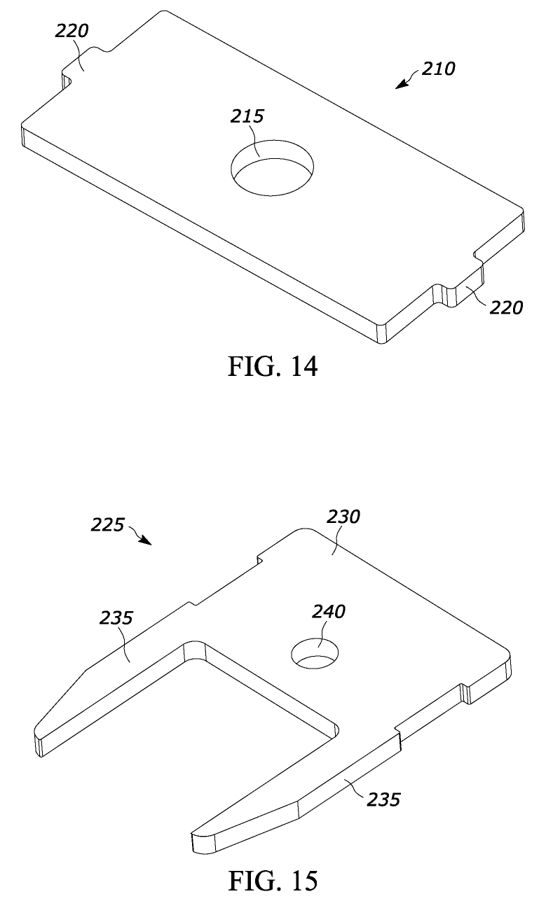

FIG. 14 shows an exemplary configuration of the interior plate 210. The interior plate 210 may have a substantially rectangular shape that is similar to the shape of the body 165 of the first clip 160. However, other examples of the interior plate 210 may have a different shape.

In some forms, the interior plate 210 may include an aperture 215 disposed in a central region of the plate 210. Although other examples may include an aperture 215 disposed at a different location. Two tabs 220 may extend from the interior plate 210. In the illustrated example, one tab 220 may extend from either side edge of the interior plate 210. In some forms, the tabs 220 may be aligned along an axis that extends across a width of the aperture 215. The tabs 220 may be received in the upper or second slots 145, 155 of the base 105.

FIG. 15 shows an exemplary configuration of an upper plate 225. The upper plate 225 may include a body 230 and a pair of projections 235 that extend away from the body 230. The illustrated upper plate 225 may have a substantially U-shape, although other examples of the upper plate 225 may have a different shape. In some forms, the upper plate 225 may include an aperture 240 that is disposed through the body 230.

Returning to FIGS. 2 to 6, the mounting bracket 100 may be assembled by connecting the first and second clips 160, 190 to the base 105. For example, each clip 160, 190 may be positioned at least partially into the interior volume 135.

In some forms, the body 195 of the second clip 190 may be positioned at least partially within the interior volume 135 of the base 105. The shape of the body 195 may be configured to extend at least partially across the interior volume 135 (e.g., at least substantially the distance between the first and second side walls 125, 130). The body 195 may be oriented to extend across the interior volume 135 so that the tabs 205 are aligned with the first slots 140, 150. In the illustrated example, the first slots 140, 150 may be substantially the same size as the tabs 205. Once inserted, the second clip 190 may be substantially fixed relative to the base 105.

When the second clip 190 is connected to the base 105, the second finger 200 may be disposed outside of the interior volume 135. For example, the second finger 200 may be oriented so that it extends toward the lower end (e.g., toward the bottom wall 115) of the base 105.

In some forms, the body 165 of the first clip 160 may be positioned at least partially within the interior volume 135 of the base 105. The shape of the body 165 may be configured to extend at least partially across the interior volume 135 (e.g., the distance between the first and second side walls 125, 130). The body 165 may be oriented to extend across the interior volume 135 so that the tabs 185 are aligned with the second slots 145, 155.

As shown in FIGS. 2 to 4, the second slots 145, 155 may be larger than a size of the tabs 185. The first clip 160 may be movable (e.g., translatable) along at least a portion of the length of the second slots 145, 155. As described in more detail below, the first clip 160 may be adjustable relative to the base 105 to change the position of the first finger 170.

When the first clip 160 is connected to the base 105, the first finger 170 may be disposed outside of the interior volume 135. For example, the first finger 170 may be oriented so that it extends toward the upper end (e.g., in an opposite direction from the second finger 200) of the base 105.

With continued reference to FIGS. 2 to 4, the tabs 220 of the interior plate 210 may also be received within the second slots 145, 155. For example, the interior plate 210 may be disposed between the first and second clips 160, 190. However, other examples may include different configurations.

As shown in FIG. 2, the upper plate 225 may be disposed against an upper edge of the base 105 to at least partially enclose the interior volume 135. The upper plate 225 may be oriented so that the body 230 is disposed over the first and second clips 160, 190. The pair of projections 235 may extend toward the end wall 120. In some forms, a distance between the pair of projections 235 may be approximately the width of the receiver 110. The receiver 110 may be received into the interior volume 135 between the pair of projections 235. Other configurations may also be used.

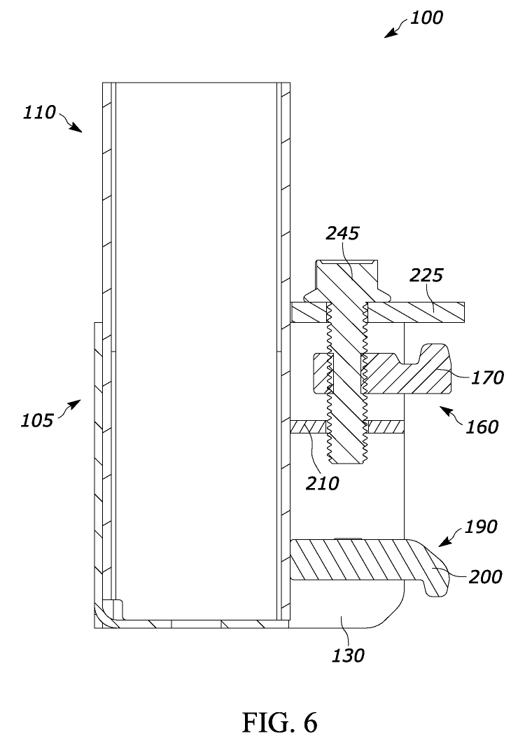

As shown in FIG. 6, the top plate 225, the first clip 160, and the interior plate 210 may be oriented so that the apertures 215, 240 and the fastener opening 180 are aligned with one another. A fastener 245 (e.g., a threaded fastener) may be inserted through the apertures 215, 240 and the fastener opening 180. The fastener 245 may help to retain the first clip 160 and/or the interior plate 210 in position relative to the base 105.

In use, the assembled mounting bracket 100 may be connected to the nose 50. More specifically, the first and second clips 160, 190 may each engage one of the channels 60, 70 on the nose 50.

In some forms, a user may orient the mounting bracket 100 so that the second clip 190 is disposed proximate to the lower channel 70 of the nose 50. The second finger 200 of the second clip 190 may pass over the overhang 80 so that it is received within the lower channel 70.

Once the second clip 190 is engaged with the nose 50, the user may pivot the mounting bracket 100 toward the nose 50 so that the first clip 160 moves toward the upper channel 60. In some forms, the user may adjust the position of the first clip 160 to permit it to move around the overhang 80 and into the upper channel 60.

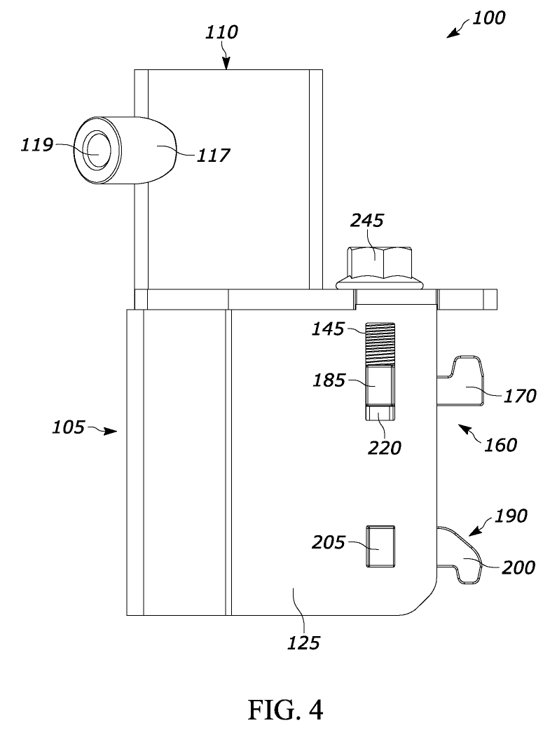

In certain forms, the user may adjust the adjustment mechanism 245, for example a fastener, to change the position of the first clip 160. For example, the user may rotate the fastener 245 (e.g., using a tool) to cause the position of the first clip 160 to change within the second slots 145, 155. The user may rotate the fastener 245 in a first direction (e.g., counterclockwise) to cause the tabs 185 to move along the second slots 145, 155 toward a lower end of the base 105 (e.g., toward the second clip 190). As shown in FIG. 4, the interior plate 210 may remain stationary at a lower end of the second slots 145, 155, and the first clip 160 can move along the second slots 145, 155 to contact the interior plate 210.

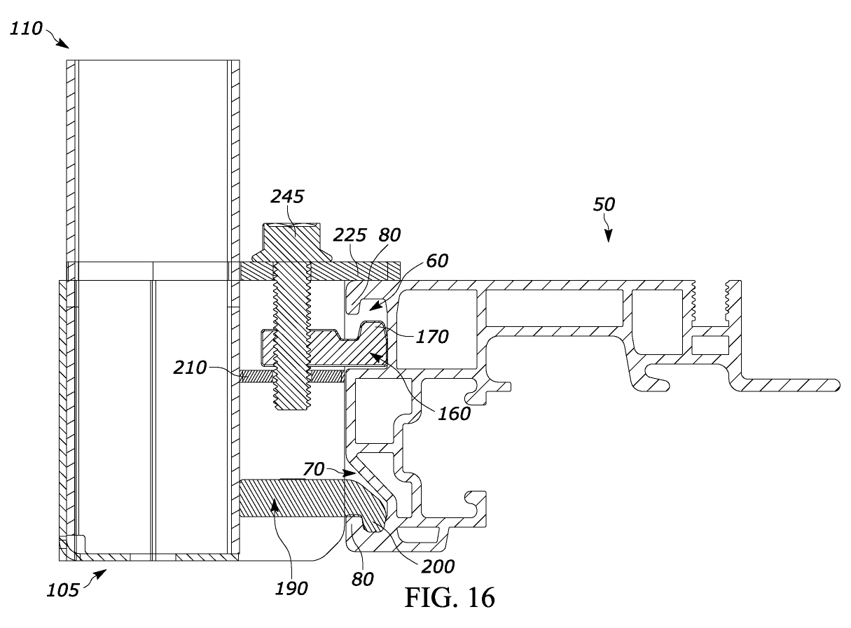

As shown in FIG. 16, the movement of the first clip 160 to the lowered, or installation position may enable the first finger 170 to avoid the overhang 80 and be received within the upper channel 60. This can be achieved through a pivoting motion of the mounting bracket 100, for example about the second clip 190 positioned in the lower channel 70.

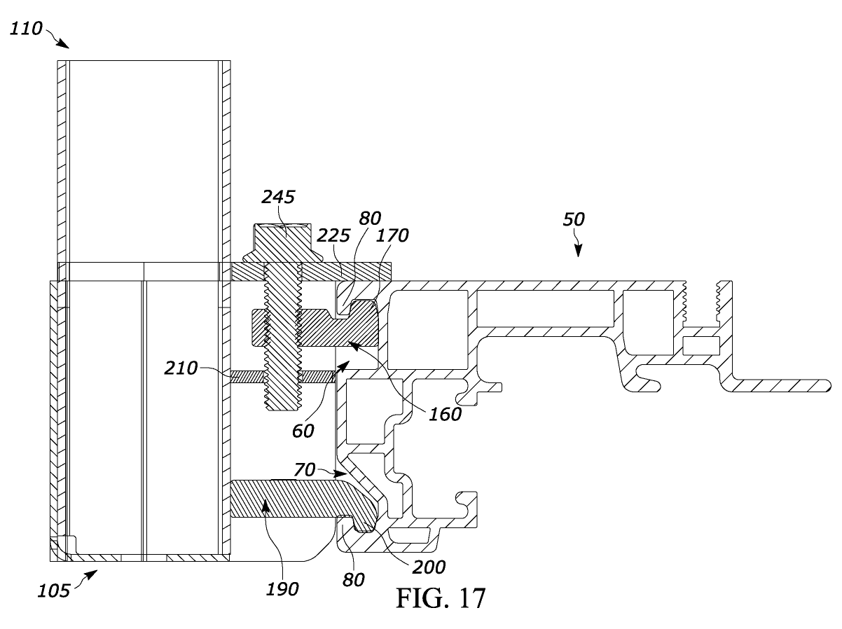

As shown in FIG. 17, with the first clip 160 positioned in the upper channel 60, the user may then rotate the fastener 245 in a second direction (e.g., clockwise) to cause the tabs 185 to move along the second slots 145, 155 toward an upper end of the base 105 (e.g., away from the second clip 190). As the first clip 160 moves away from the second clip 190, the first finger 170 passes behind the overhang 80. This may limit the first finger 170 from being removed from the upper channel 60 and thereby secure the mounting bracket 100 to the nose 50. The first clip 160 can be moved to an intermediate or adjustment position that allows the mounting bracket 100 to slide in the channels 60, 70 without removal of the mounting bracket 100. This can allow a user to adjust the position of the mounting bracket 100 and an associated accessory more easily without having to hold it in place by hand. The first clip 160 can then be moved further to secure the position of the mounting bracket 100 relative to the nose 50.

In other examples, the second clip 190 may be movable relative to the base 105 instead of or in addition to the first clip 160 moving relative to the base 105. For example, the first slots 140, 150 may be longer to permit the tabs 205 to move within the first slots 140, 150 and adjust the position of the second clip 190 relative to the base 105. In some forms, an additional fastener may be received through the second clip 190 to permit a technician to rotate the fastener and adjust the position of the second clip 190.

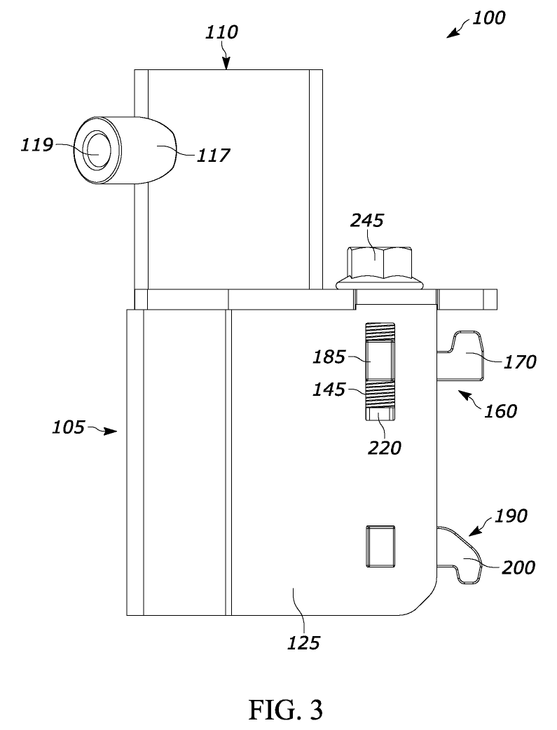

In still other examples, a biasing member (e.g., a spring) may assist in maintaining the position of the first clip 160 (or the second clip 190). For example, the biasing member may be added to or replace the fastener 245 and maintain the first clip 160 in a neutral position (see e.g., FIG. 3). When installing the mounting bracket 100 to the nose 50, the user may move the first clip 160 against the bias of the biasing member (e.g., causing the spring to compress or stretch depending on the location of the spring) to permit the first finger 170 to move around the overhang 80. Once the first finger 170 is received within the upper channel 60, the technician can release the first clip 160 so that the first finger 170 is disposed behind the overhang 80 and the mounting bracket 100 is secured to the nose 50. When a fastener 245 is used, the fastener 245 can be tightened to further secure the position. The biasing member can also provide a loading force to help prevent unwanted loosening of the fastener 245.

Once the mounting bracket 100 is connected to the nose 50, an accessory may be connected to the receiver 110. For example, a seating element (e.g., a bleacher seat), a railing, or any other accessory may be connected to one or more mounting brackets 100 connected to the nose 50. In some forms, the mounting bracket 100 may be movable along the channels 60, 70 to position the accessory at different locations along the nose 50. A shaft or member of the accessory may be received or nested within the receiver 110. A user may insert or slide the accessory a desired length into the receiver 110. To secure the accessory in the desired location, the user may position an insert or fastener through the opening 119 of the protrusion 117. The insert may engage a portion of the accessory to limit relative movement between the accessory and the receiver 110.

In alternate examples, the accessory and receiver 110 may be connected before the mounting bracket 100 is connected to the nose 50. In still other examples, the accessory and the receiver 110 may be integrally formed as a single unit, so that a user does not need to connect the accessory to the mounting bracket 100. In this example, a different mounting bracket 100 and accessory combination may be used for different types of accessories.

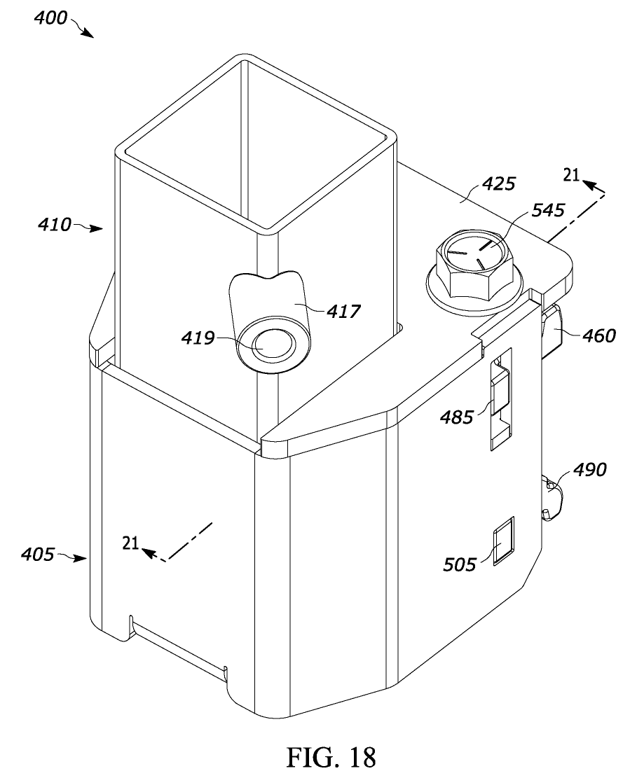

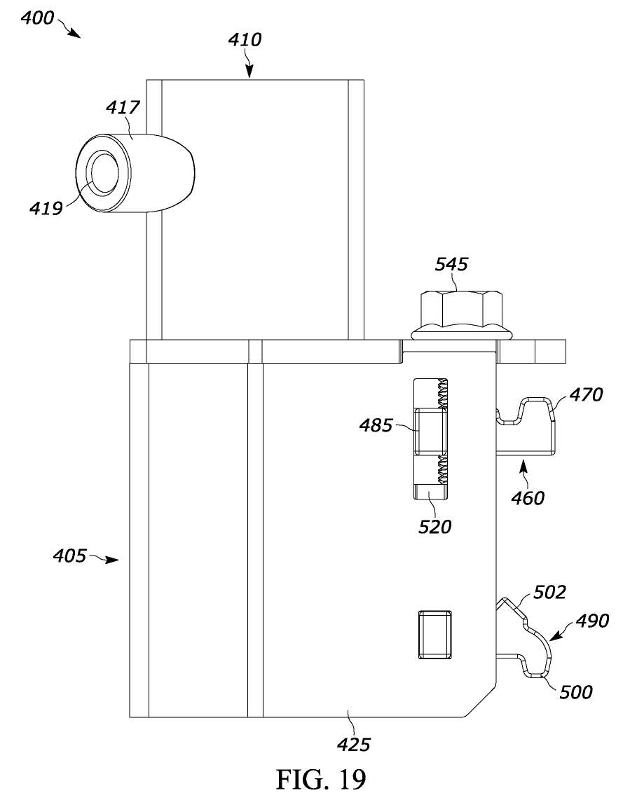

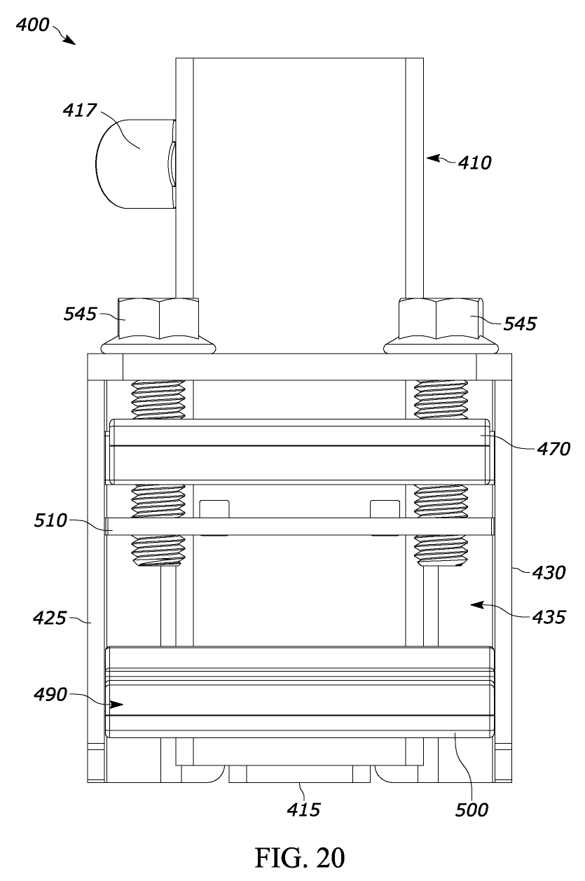

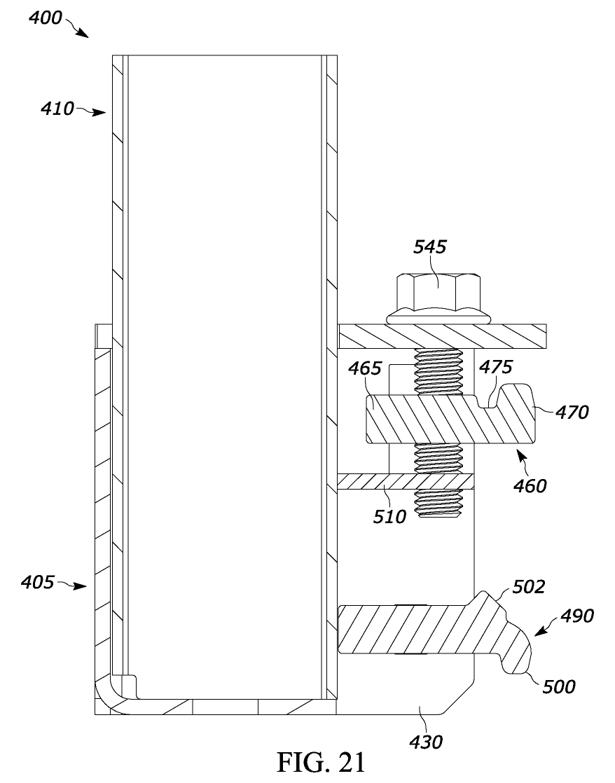

FIGS. 18 to 24 illustrate mounting bracket 400, which is an alternate example of the mounting bracket 100. Similar elements include the same reference number plus “300”. Only some similarities and differences are disclosed.

As shown in FIGS. 18 to 24, the mounting bracket 400 includes a base 405. A first clip 460 is connected to the base 405 and a second clip 490 is connected to the base 405. At least one of the first clip 460 and second clip 490 can be moveable relative to the base 405 to secure the mounting bracket 400 to the nose 50. Movement can be caused by an adjustment mechanism 545, such as a pair of threaded fasteners, though other mechanisms may also be used. In some forms, an interior plate 510 and an upper plate 525 are also connected to the base 405.

In some forms, a receiver 410 is connected to the base 405. The receiver 410 may be fixed to the base 405. The receiver 410 may include a protrusion 417 that may be disposed proximate to an upper end of the receiver 410 (e.g., the protrusion 417 may be spaced apart from the base 405). The protrusion 417 may include an opening 419 (e.g., a threaded opening), which can receive an insert or fastener. As described in more detail below, the receiver 410 may support an accessory when the mounting bracket 400 is coupled to the nose 50.

In some forms, the base 405 may include a bottom wall 415, an end wall 420, a first side wall 425, and a second side wall 430. In the illustrated example, the walls of the base 405 may be integrally formed in a one-piece construction. However, other examples of the base 405 may include one or more of the walls that are formed separately and connected with a mechanical fastener, adhesive, or through a joining process (e.g., welded) to the one or more adjacent walls.

In some forms, the first side wall 425 may include a first slot 440 and a second slot 445. The illustrated first and second slots 440, 445 may be disposed proximate to a free end of the first side wall 425 and may be aligned along an axis (e.g., an axis extending along a height direction of the first side wall 425). The second side wall 430 may similarly include a first slot and a second slot. The first and second slots of the second side wall 430 may be respectively aligned with the first and second slots 440, 445 of the first side wall 425 across the width of the interior volume 435 such that the first slot 440 of the first side wall 425 is aligned with the first slot of the second side wall 430 and the second slot 445 of the first side wall 425 is aligned with the second slot of the second side wall 430.

In certain configurations the first slots are configured to receive the second clip 490 and the second slots are configured to receive the first clip 460 and the interior plate 510, although other arrangements can also be used.

The first clip 460 may include a body 465 and a first finger 470 that extends from the body 465. The body 465 may have a substantially rectangular shape, although other examples of the body 465 may include a different shape. The first finger 470 may extend from an end of the body 465 and may extend along substantially the entire length of the body 465. In other examples, the first finger 470 may extend along only a portion of the body 465 and/or the body 465 may include multiple fingers (e.g., two or more discontinuous fingers). A groove 475 may be disposed between the first finger 470 and a central region of the body 465. Tabs 485 may extend from either side of the body 465 and can be received in the second slots.

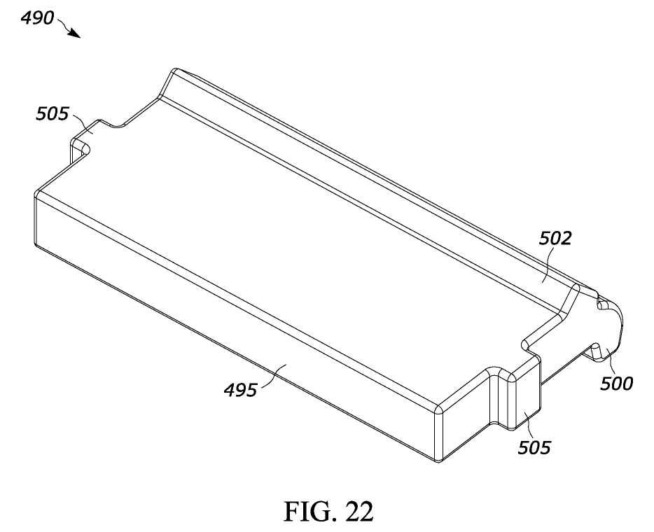

As shown in FIG. 22, a second clip 490 may include a body 495 and a second finger 500 that extends from the body 495. The body 495 may have a substantially rectangular shape, although other examples of the body 495 may include a different shape. In some forms, the body 495 may have a substantially similar shape as the body 465. The second finger 500 may extend from an end of the body 495 and may extend along substantially the entire length of the body 495. In other examples, the second finger 500 may extend along only a portion of the body 495 and/or the body 495 may include multiple fingers (e.g., two or more discontinuous fingers). Two tabs 505 may extend from the body 495 and can be received in the first slots.

In some forms, the body 495 of the second clip 490 may include a protrusion 502 that projects in the opposite direction as the second finger 500. In the illustrated example, the protrusion 502 may be disposed proximate to an end of the body 495 adjacent to the second finger 500. The protrusion 502 may be formed from a pair of inclined surfaces. As described in more detail below, the protrusion 502 may be configured to engage the channel 70 of the nose 50.

Returning to FIG. 18, the upper plate 525 may include a body 530 and a pair of projections 535 that extend away from the body 530. The illustrated upper plate 525 may have a substantially U-shape, although other examples of the upper plate 525 may have a different shape. In some forms, the upper plate 525 may include a pair of apertures that are disposed through the body 530.

As shown in FIGS. 18 to 21, the mounting bracket 400 may be assembled by connecting the first and second clips 460, 490 to the base 405. For example, each clip 460, 490 may be positioned at least partially into the interior volume 435. Once inserted, the second clip 490 may be substantially fixed relative to the base 405. The second finger 500 may be oriented so that it extends toward the lower end.

In some forms, the body 465 of the first clip 460 may be positioned at least partially within the interior volume 435 of the base 405. The shape of the body 465 may be configured to extend at least partially across the interior volume 435 (e.g., the distance between the first and second side walls 425, 430). The body 465 may be oriented to extend across the interior volume 435 so that the tabs 485 are aligned with the second slots, which may be larger than a size of the tabs 485. The first clip 460 may be movable (e.g., translatable) along at least a portion of the length of the second slots.

When the first clip 460 is connected to the base 405, the first finger 470 may be disposed outside of the interior volume 435. For example, the first finger 470 may be oriented so that it extends toward the upper end (e.g., in an opposite direction from the second finger 500) of the base 405.

The upper plate 525 may be disposed against an upper edge of the base 405 to at least partially enclose the interior volume 435. The upper plate 525 may be oriented so that the body 530 is disposed over the first and second clips 460, 490. The pair of projections 535 may extend toward the end wall 420. In some forms, a distance between the pair of projections 535 may be approximately the width of the receiver 410. The receiver 410 may be received into the interior volume 435 between the pair of projections 535. Other configurations may also be used.

The top plate 525, the first clip 460, and the interior plate 510 may be oriented so that the apertures and the fastener opening are aligned with one another. Fasteners 545 (e.g., threaded fasteners) may be inserted through the apertures 515, 540 and the fastener opening 480. The fastener 545 may help to retain the first clip 460 and/or the interior plate 510 in position relative to the base 405. In use, the assembled mounting bracket 400 may be connected to the nose 50. More specifically, the first and second clips 460, 490 may each engage one of the channels 60, 70 on the nose 50.

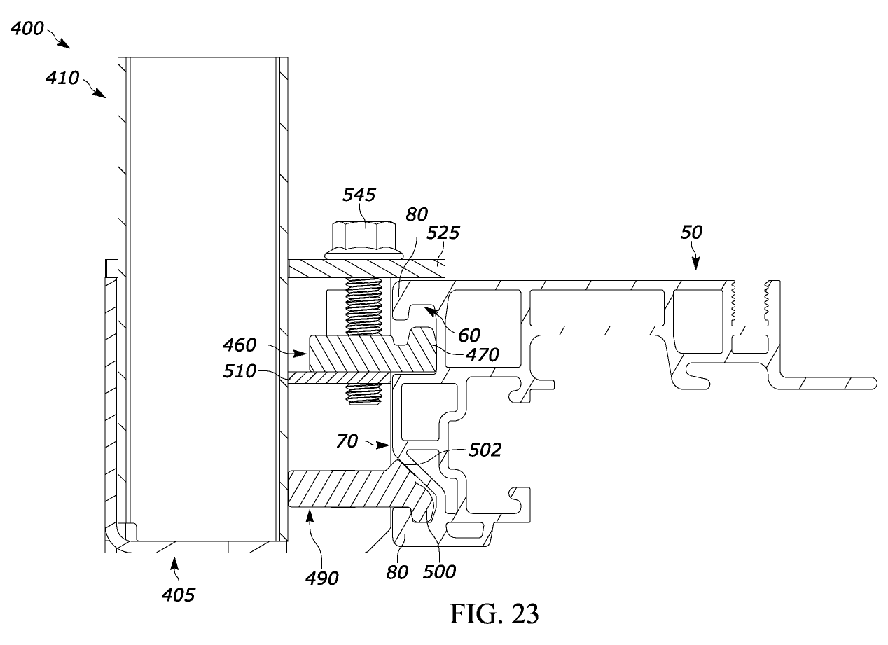

In some forms, a user may orient the mounting bracket 400 so that the second clip 490 is disposed proximate to the lower channel 70 of the nose 50. The second finger 500 of the second clip 490 may pass over the overhang 80 so that it is received within the lower channel 70. Once the second clip 490 is engaged with the nose 50, the user may pivot the mounting bracket 400 toward the nose 50 so that the first clip 460 moves toward the upper channel 60. As the mounting bracket 400 is pivoted, the protrusion 502 may move into contact with the wall of the channel 70. The angle of the protrusion 502 may be similar to the shape of the channel 70. The protrusion 502 may therefore act as a stop to alert the user that the mounting bracket 400 has been pivoted into the proper position (see e.g., FIG. 23). In some forms, the user may adjust the position of the first clip 460 to permit it to move around the overhang 80 and into the upper channel 60.

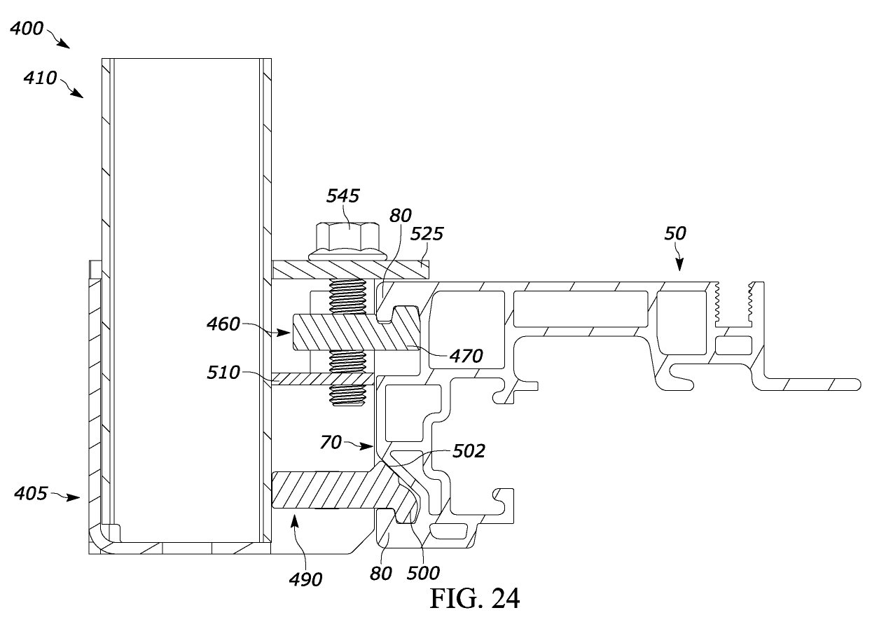

In certain forms, the user may adjust the adjustment mechanisms 545, for example the fasteners, to change the position of the first clip 460. For example, the user may rotate each of the fasteners 545 (e.g., using a tool) to cause the position of the first clip 460 to change within the second slots. The user may rotate the fasteners 545 in a first direction (e.g., counterclockwise) to cause the tabs 485 to move along the second slots toward a lower end of the base 405 (e.g., toward the second clip 490). As shown in FIG. 24, the interior plate 510 may remain stationary at a lower end of the second slots, and the first clip 460 can move along the second slots to contact the interior plate 510.

As shown in FIG. 23, the movement of the first clip 460 to the lowered, or installation position may enable the first finger 470 to avoid the overhang 80 and be received within the upper channel 60. This can be achieved through a pivoting motion of the mounting bracket 400, for example about the second clip 490 positioned in the lower channel 70.

As shown in FIG. 24, with the first clip 460 positioned in the upper channel 60, the user may then rotate the fasteners 545 in a second direction (e.g., clockwise) to cause the tabs 485 to move along the second slots toward an upper end of the base 405 (e.g., away from the second clip 490). As the first clip 460 moves away from the second clip 490, the first finger 470 passes behind the overhang 80. This may limit the first finger 470 from being removed from the upper channel 60 and thereby secure the mounting bracket 400 to the nose 50. The first clip 460 can be moved to an intermediate or adjustment position that allows the mounting bracket 400 to slide in the channels 60, 70 without removal of the mounting bracket 400. This can allow a user to adjust the position of the mounting bracket 400 and an associated accessory more easily without having to hold it in place by hand. The first clip 460 can then be moved further to secure the position of the mounting bracket 400 relative to the nose 50.

Once the mounting bracket 400 is connected to the nose 50, an accessory may be connected to the receiver 410. For example, a seating element (e.g., a bleacher seat), a railing, or any other accessory may be connected to one or more mounting brackets 400 connected to the nose 50. In some forms, the mounting bracket 400 may be movable along the channels 60, 70 to position the accessory at different locations along the nose 50. A shaft or member of the accessory may be received or nested within the receiver 410. A user may insert or slide the accessory a desired length into the receiver 410. To secure the accessory in the desired location, the user may position an insert or fastener through the opening 419 of the protrusion 417. The insert may engage a portion of the accessory to limit relative movement between the accessory and the receiver 410.

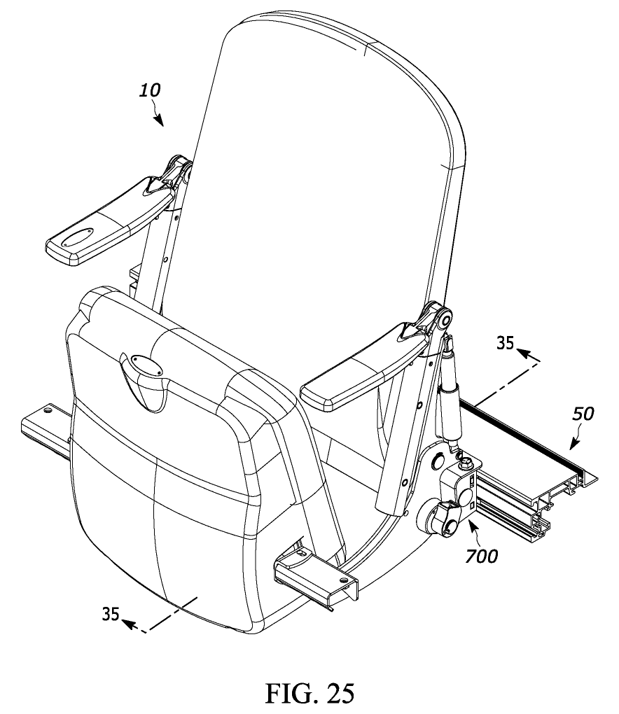

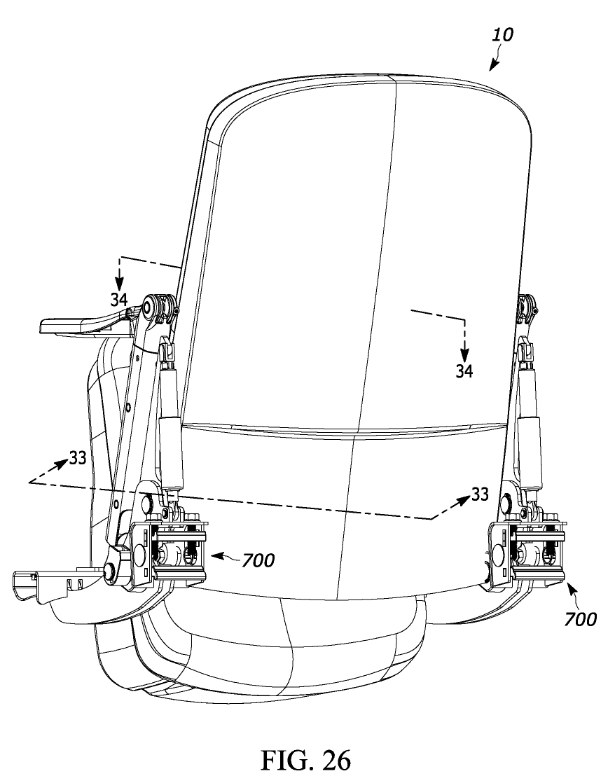

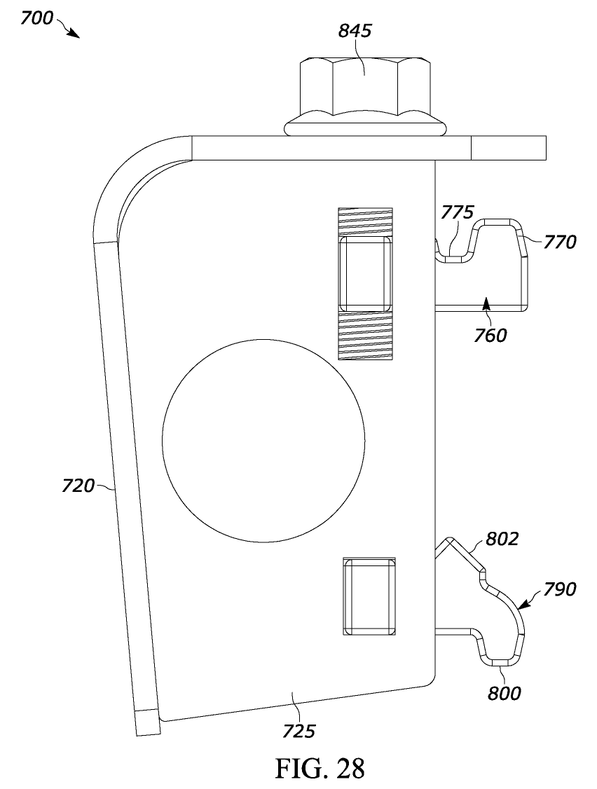

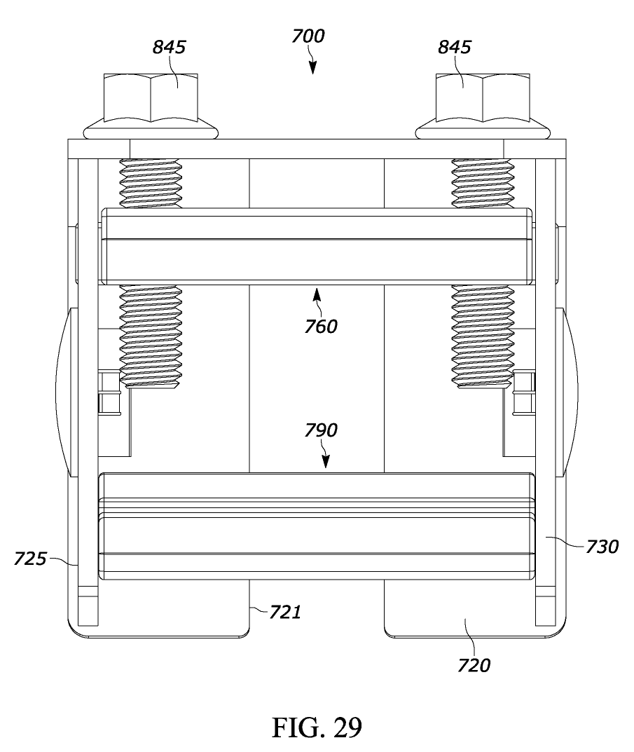

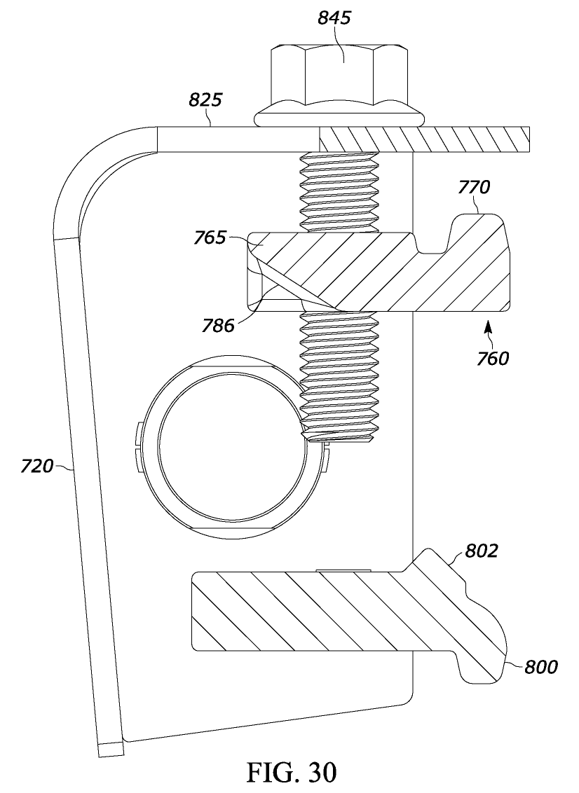

FIGS. 25 to 35 illustrate mounting bracket 700, which is an alternate example of the mounting bracket 100. Similar elements include the same reference number plus “600”. Only some similarities and differences are disclosed. The mounting bracket 700 may be specifically used for connecting a seat 10 to a nose 50.

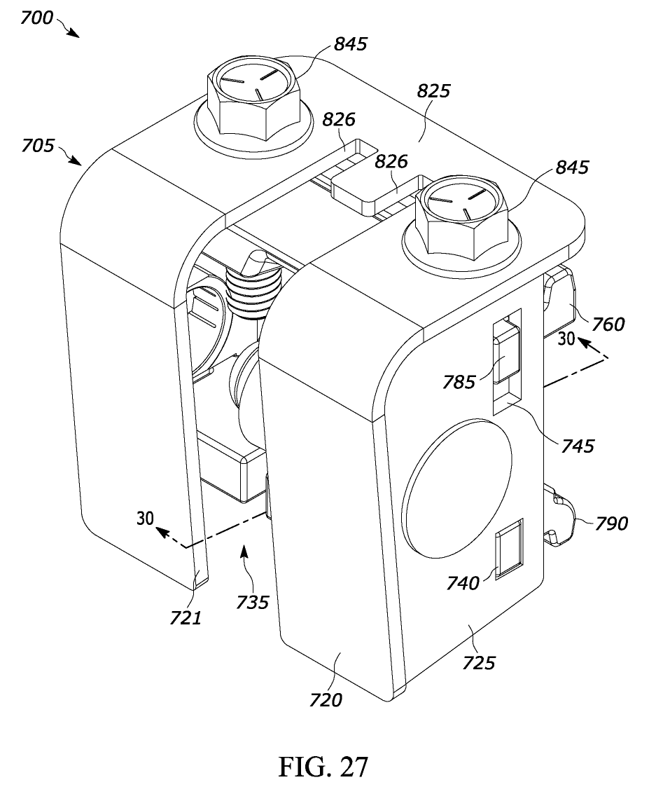

FIGS. 27 to 30 show an exemplary configuration of the mounting bracket 700 that includes a base 705. A first clip 760 is connected to the base 705 and a second clip 790 is connected to the base 705. At least one of the first clip 760 and second clip 790 can be moveable relative to the base 705 to secure the mounting bracket 700 to the nose 50. Movement can be caused by an adjustment mechanism 845, such as a pair of threaded fasteners, though other mechanisms may also be used.

In some forms, the base 705 may include an end wall 720, a first side wall 725, and a second side wall 730. The walls of the base 705 may be coupled together (e.g., by welding) or may be integrally formed in a one-piece construction. The first side wall 725 may include a first slot 740 and a second slot 745. The illustrated first and second slots 740, 745 may be disposed proximate to a free end of the first side wall 725 and may be aligned along an axis (e.g., an axis extending along a height direction of the first side wall 725). The second side wall 730 may similarly include a first slot and a second slot. The first and second slots of the second side wall 730 may be respectively aligned with the first and second slots 740, 745 of the first side wall 725 across the width of the interior volume 735 such that the first slot 740 of the first side wall 725 is aligned with the first slot of the second side wall 730 and the second slot 745 of the first side wall 725 is aligned with the second slot of the second side wall 730. The first slots are configured to receive the second clip 790 and the second slots are configured to receive the first clip 760, although other arrangements can also be used.

In some forms, the end wall 720 may include a channel 721 that extends through the middle of the end wall 720. In the illustrated example, the channel 721 extends along an entire length of the vertical portion of the end wall 720. As described below, the channel 721 also extends along a portion of the upper section 825.

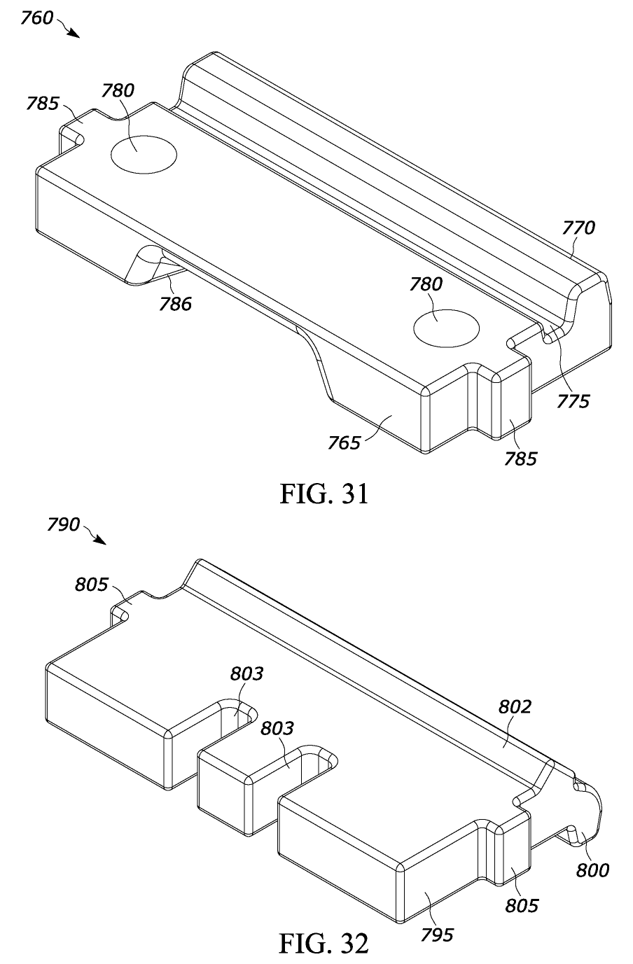

As shown in FIG. 31, the first clip 760 may include a body 765 and a first finger 770 that extends from the body 765. The body 765 may have a substantially rectangular shape, although other examples of the body 765 may include a different shape. The first finger 770 may extend from an end of the body 765 and may extend along substantially the entire length of the body 765. In other examples, the first finger 770 may extend along only a portion of the body 765 and/or the body 765 may include multiple fingers (e.g., two or more discontinuous fingers). A groove 775 may be disposed between the first finger 770 and a central region of the body 765. The body 765 may include a pair of fastener openings 780. Tabs 785 may extend from either side of the body 765 and can be received in the second slots.

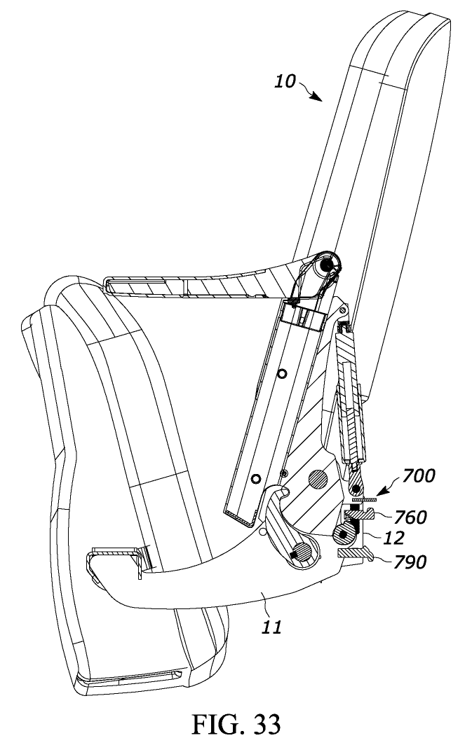

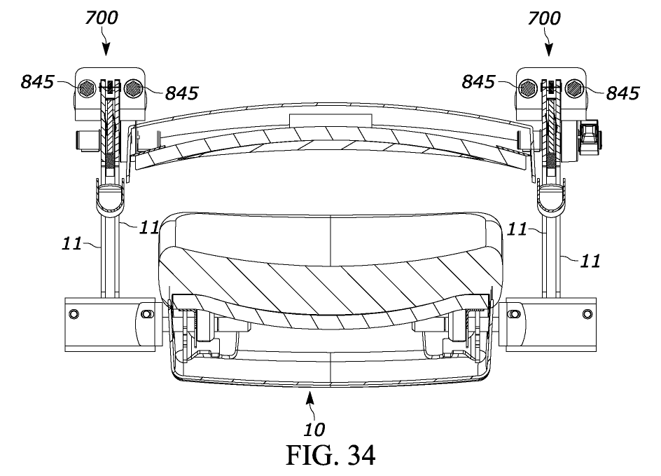

In some forms, the first clip 760 may include a cutout 786 formed at a rear of the body 765 (e.g., opposite to the first finger 770). The cutout 786 may accommodate a rotational element 12 of the seat 10. Particularly, when the first clip 760 is in a lowered position as described below, the cutout 786 may be sized to allow the rotational element 12 to fit inside and avoid contacting the body 765 (see e.g., FIG. 33).

As shown in FIG. 32, a second clip 790 may include a body 795 and a second finger 800 that extends from the body 795. The body 795 may have a substantially rectangular shape, although other examples of the body 795 may include a different shape. In some forms, the body 795 may have a substantially similar shape as the body 765. The second finger 800 may extend from an end of the body 795 and may extend along substantially the entire length of the body 795. In other examples, the second finger 800 may extend along only a portion of the body 795 and/or the body 795 may include multiple fingers (e.g., two or more discontinuous fingers). Two tabs 805 may extend from the body 795 and can be received in the first slots.

In some forms, the body 795 of the second clip 790 may include a protrusion 802 that projects in the opposite direction as the second finger 800. In the illustrated example, the protrusion 802 may be disposed proximate to an end of the body 795 adjacent to the second finger 800. The protrusion 802 may be formed from a pair of inclined surfaces. As described in more detail below, the protrusion 802 may be configured to engage the channel 70 of the nose 50.

In some forms, a rear of body 795 (e.g., opposite to the second finger 800) may include a pair of grooves 803. The grooves 803 may be substantially centered on the body 795. The grooves 803 may receive the lateral supports 11 of the seat 10.

Returning to FIG. 27, the end wall 720 may have a substantially L-shape so that it includes two substantially perpendicular sections that are integrally formed in one piece. In some forms, the upper section 825 may include a pair of apertures. The apertures may be disposed on either side of the channel 721.

In some forms, a pair of grooves 826 may be formed in the upper section at an end of the channel 721. The pair of grooves 826 may be shaped similarly to the pair of grooves 803, and may also be aligned with the pair of grooves 803. The pair of grooves 826 in the upper section 825 may be similarly configured to receive the lateral supports 11 (see e.g., FIG. 34).

As shown in FIGS. 27 to 30, the mounting bracket 700 may be assembled by connecting the first and second clips 760, 790 to the base 705. For example, each clip 760, 790 may be positioned at least partially into the interior volume 735. Once inserted, the second clip 790 may be substantially fixed relative to the base 705. The second finger 800 may be oriented so that it extends toward the lower end.

In some forms, the body 765 of the first clip 760 may be positioned at least partially within the interior volume 735 of the base 705. The shape of the body 765 may be configured to extend at least partially across the interior volume 735 (e.g., the distance between the first and second side walls 725, 730). The body 765 may be oriented to extend across the interior volume 735 so that the tabs 785 are aligned with the second slots, which may be larger than a size of the tabs 785. The first clip 760 may be movable (e.g., translatable) along at least a portion of the length of the second slots.

When the first clip 760 is connected to the base 705, the first finger 770 may be disposed outside of the interior volume 735. For example, the first finger 770 may be oriented so that it extends toward the upper end (e.g., in an opposite direction from the second finger 800) of the base 705.

The first clip 760 and the top section 825 may be oriented so that the apertures and the fastener opening are aligned with one another. Fasteners 845 (e.g., threaded fasteners) may be inserted through the apertures and the fastener opening 780. The fasteners 845 may help to retain the first clip 760 in position relative to the base 705. In use, the assembled mounting bracket 700 may be connected to the nose 50. More specifically, the first and second clips 760, 790 may each engage one of the channels 60, 70 on the nose 50.

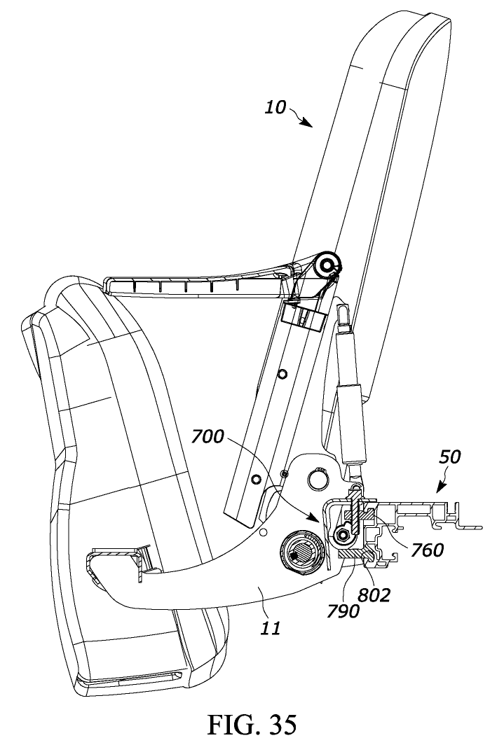

In some forms, a user may orient the mounting bracket 700 so that the second clip 790 is disposed proximate to the lower channel 70 of the nose 50. The second finger 800 of the second clip 790 may pass over the overhang 80 so that it is received within the lower channel 70. Once the second clip 790 is engaged with the nose 50, the user may pivot the mounting bracket 700 toward the nose 50 so that the first clip 760 moves toward the upper channel 60. As the mounting bracket 700 is pivoted, the protrusion 802 may move into contact with the wall of the channel 70. The angle of the protrusion 802 may be similar to the shape of the channel 70. The protrusion 802 may therefore act as a stop to alert the user that the mounting bracket 700 has been pivoted into the proper position (see e.g., FIG. 35). In some forms, the user may adjust the position of the first clip 760 to permit it to move around the overhang 80 and into the upper channel 60.

In certain forms, the user may adjust the adjustment mechanisms 845, for example the fasteners, to change the position of the first clip 760. For example, the user may rotate each of the fasteners 845 (e.g., using a tool) to cause the position of the first clip 760 to change within the second slots. The user may rotate the fasteners 845 in a first direction (e.g., counterclockwise) to cause the tabs 785 to move along the second slots toward a lower end of the base 705 (e.g., toward the second clip 790).

As shown in FIG. 35, the movement of the first clip 760 to the lowered, or installation position may enable the first finger 770 to avoid the overhang 80 and be received within the upper channel 60. This can be achieved through a pivoting motion of the mounting bracket 700, for example about the second clip 790 positioned in the lower channel 70.

With the first clip 760 positioned in the upper channel 60, the user may then rotate the fasteners 845 in a second direction (e.g., clockwise) to cause the tabs 785 to move along the second slots toward an upper end of the base 705 (e.g., away from the second clip 790). As the first clip 760 moves away from the second clip 790, the first finger 770 passes behind the overhang 80. This may limit the first finger 770 from being removed from the upper channel 60 and thereby secure the mounting bracket 700 to the nose 50. The first clip 760 can be moved to an intermediate or adjustment position that allows the mounting bracket 700 to slide in the channels 60, 70 without removal of the mounting bracket 700. This can allow a user to adjust the position of the mounting bracket 700 and an associated accessory more easily without having to hold it in place by hand. The first clip 760 can then be moved further to secure the position of the mounting bracket 700 relative to the nose 50.

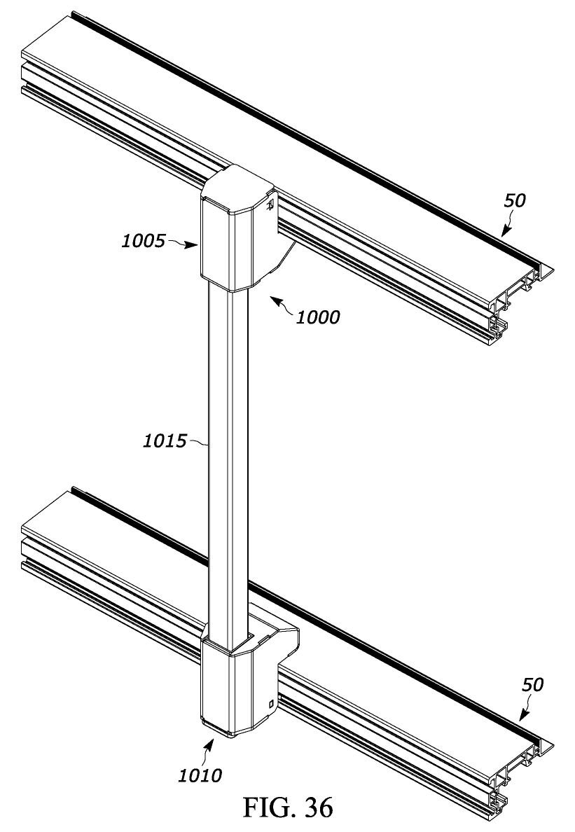

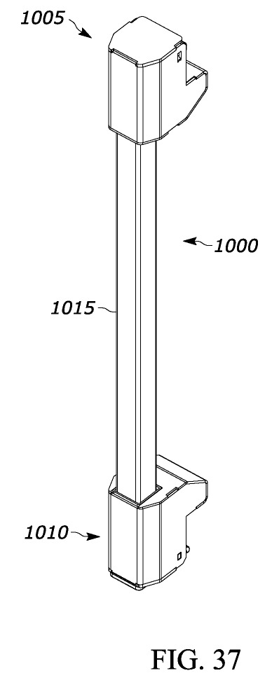

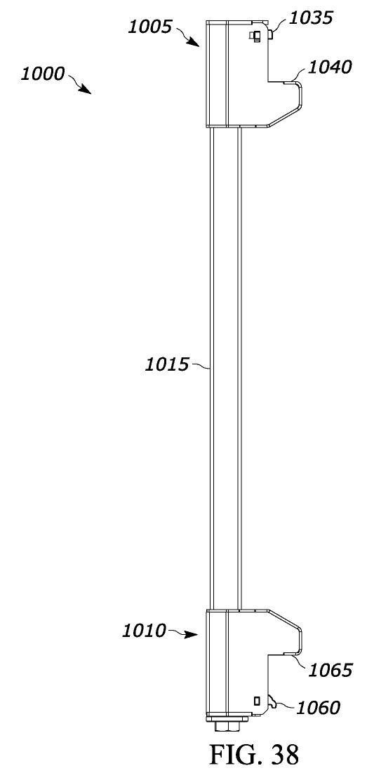

FIGS. 36 to 44 illustrate another example of a mounting bracket 1000, which may be specifically designed to connect to a pair of noses 50 on separate tiers of a bleacher system. The mounting bracket 1000 may include an upper portion 1005, a lower portion 1010, and a support beam 1015 that extends between the upper and lower portions 1005, 1010. The support beam 1015 can extend between different tiers of a seating system as needed to provide additional support. For example, in some implementations one or more lower tiers of a seating system may be partially retracted so that they are positioned underneath of an upper tier. The support beam 1015 can be used to provide additional support to the upper tier by connecting to the lower tier and providing an additional load path.

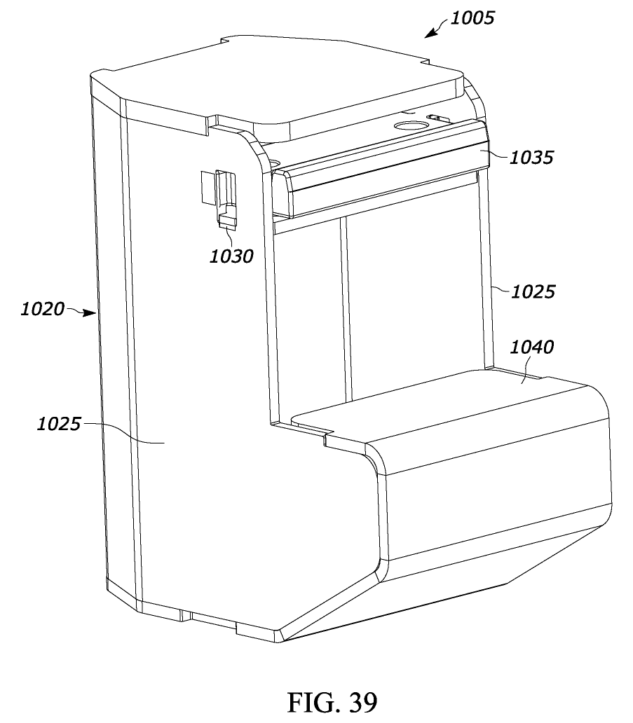

As shown in FIG. 39, the upper portion 1005 may include a body 1020 that can be formed with a substantially L-shape. The body 1020 may be formed from a plurality of connected panels or may be integrally formed in a one-piece construction. In some forms, the body 1020 may include a pair of side walls 1025, each of which may include the substantially L-shape. Each side wall 1025 may include a slot 1030.

In some forms, a first clip 1035 may be coupled between the side walls 1025. The first clip 1035 may be similar to any of the above described first clips (e.g., first clip 160). Like the previously described first clips, the first clip 1035 may include projections that are received in the slots 1030. The projections of the first clip 1035 may be smaller than the length of the slots 1030 to permit the first clip 1035 to translate along the slots 1030.

In certain forms, a stop surface 1040 may project beyond an end of the first clip 1035. The stop surface 1040 may be a horizontal surface as viewed in the orientation of FIG. 39. The stop surface 1040 may also be formed between the side walls 1025 and may be perpendicular to the side walls 1025.

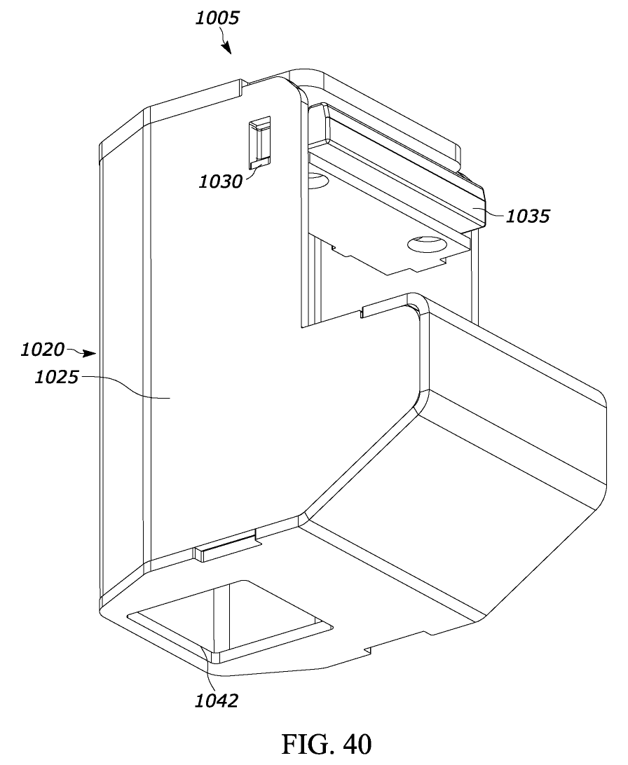

As shown in FIG. 40, the body 1020 may include a connecting aperture 1042. In the illustrated example, the connecting aperture 1042 may have a rectangular shape, however other examples may have different shapes. As described in more detail below, the connecting aperture 1042 may be configured to receive the support beam 1015.

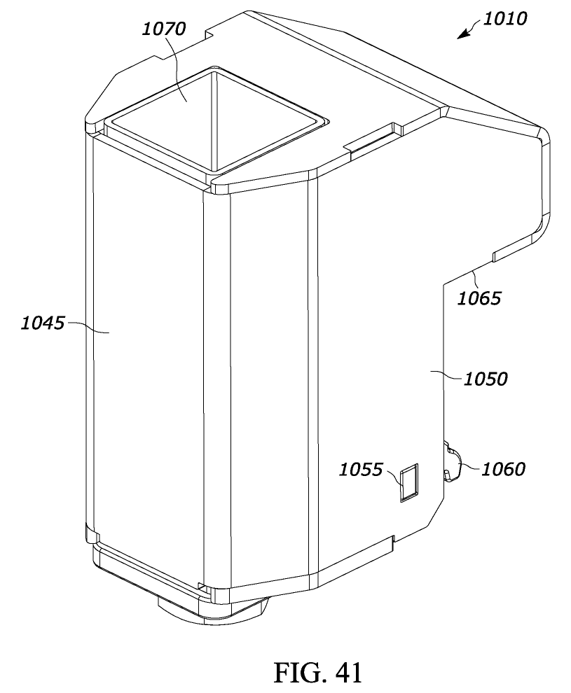

As shown in FIG. 41, the lower portion 1010 may include a body 1045 that can be formed with a substantially L-shape. The body 1045 may be formed from a plurality of connected panels or may be integrally formed in a one-piece construction. In some forms, the body 1045 may include a pair of side walls 1050, each of which may include the substantially L-shape. Each side wall 1050 may include a slot 1055. The body 1045 of the lower portion 1010 may have a similar outer shape as the body 1020 of the upper portion 1005. However, as described below, the slot 1055 may be smaller than the slot 1030.

In some forms, a second clip 1060 may be coupled between the side walls 1050. The second clip 1060 may be similar to any of the above-mentioned clips (e.g., second clip 190). Like the previously described clips, the second clip 1060 may include projections that are received in the slots 1055. The projections of the second clip 1060 may be approximately the same size as the slots 1055 to permit the second clip 1060 to remain fixed within the slots 1055.

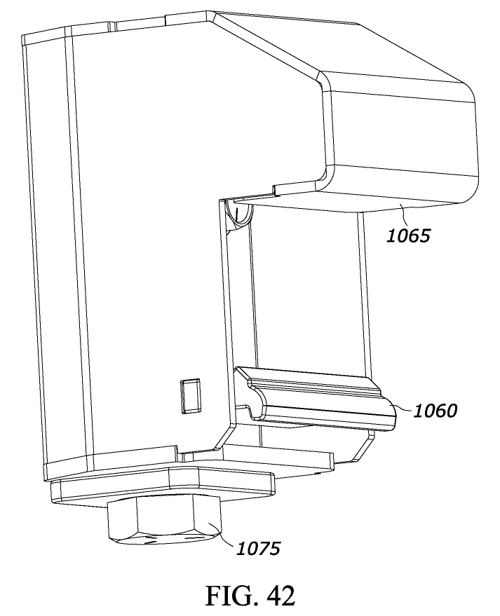

In certain forms, a stop surface 1065 may project beyond an end of the second clip 1060. The stop surface 1065 may be a horizontal surface as viewed in the orientation of FIG. 42. The stop surface 1065 may also be formed between the side walls 1050 and may be perpendicular to the side walls 1050.

As shown in FIG. 41, the body 1045 may include a connecting aperture 1070. In the illustrated example, the connecting aperture 1070 may have a rectangular shape, however other examples may have different shapes. As described in more detail below, the connecting aperture 1070 may be configured to receive the support beam 1015. The lower portion 1010 may also include a fastener 1075 securing a lower plate.

The mounting bracket 1000 may be used to connect to different tiers of a bleacher system. Some types of events may not require the bleacher system to be fully extended. For example, while bleacher systems may be fully extended when used with a basketball court, they may need to remain partially stacked to fit a hockey rink. As shown in FIG. 36, the mounting bracket 1000 may be positioned at an end of the bleacher system and connected to two spaced apart noses 50, representing two unstacked tiers.

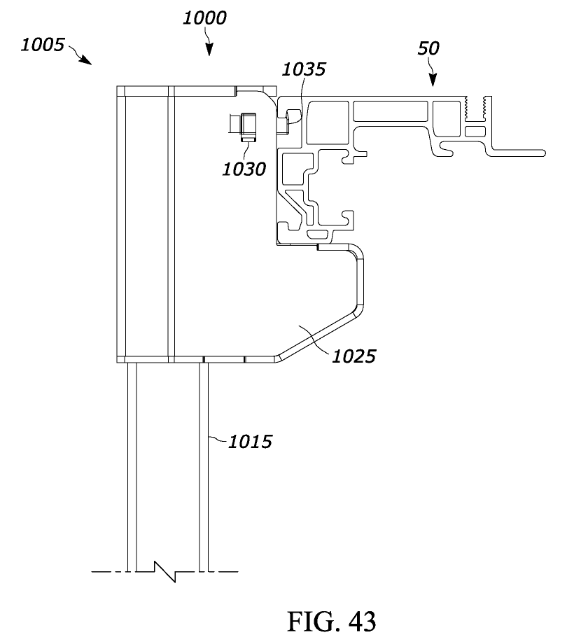

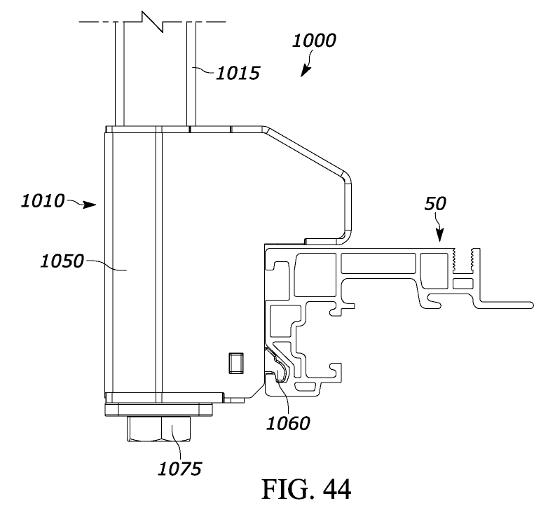

As shown in FIGS. 43 and 44, the upper and lower portions 1005, 1010 can connect to the channels 60, 70 of the respective noses 50 in a similar manner as described above. For example, the first and second clips 1035, 1060 may connect to the respective channels 60, 70 in the same manner as described above. The second clip 1060 may be inserted into the channel 70 and the mounting bracket 1000 may pivot so that the first clip 1035 can be received in channel 60. The support beam 1015 may maintain a constant spacing between the upper and lower portions 1005, 1010. When connected, the stop surfaces 1040, 1065 abut against a surface of the respective nose 50 to limit translational movement in the vertical direction. In some forms, the support beam 1015 may be extendable (e.g., telescopically extendable) and/or replaceable with a differently sized support beam 1015 depending on the spacing on the noses 50.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various examples of the disclosure. Once armed with the present specification, routine experimentation is all that is needed to determine adjustments and modifications that will carry out the present disclosure.

The above examples are for illustrative purposes and are not intended to limit the scope of the disclosure or the adaptation of the features described herein. Those skilled in the art will also appreciate that various adaptations and modifications of the above-described preferred examples can be configured without departing from the scope and spirit of the disclosure. Therefore, it is to be understood that, within the scope of the appended claims, the disclosure may be practiced other than as specifically described.

What is claimed is:

1. A mounting bracket for a bleacher seating system comprising:
a base having a first side wall and a second side wall spaced apart from the first side wall, wherein an interior is formed at least partially between the first side wall and the second side wall;
a first clip connected to the base and configured to engage a first channel of a seating nose member, the first clip having a first finger extending in a first direction;
a second clip connected to the base and configured to engage a second channel of the seating nose member, the second clip having a second finger extending in a second direction opposite the first direction; and
an adjustment mechanism connected to the base and the first clip,
wherein the first clip is moveable relative to the second clip via the adjustment mechanism to secure the base to the seating nose member.

2. The mounting bracket of claim 1, wherein the adjustment mechanism includes a threaded fastener.

3. The mounting bracket of claim 1, wherein the adjustment mechanism includes a pair of threaded fasteners.

4. The mounting bracket of claim 1, wherein the first side wall includes a first slot and the second side wall includes a second slot, and wherein the first clip is moveable within the first and second slots to translate relative to the second clip.

5. The mounting bracket of claim 1, wherein the adjustment mechanism is connected to an interior plate positioned in the interior between the first clip and the second clip.

6. The mounting bracket of claim 1, wherein the second clip includes a protrusion that extends in an opposite direction as the second finger, and wherein the protrusion is configured to contact a wall of the second channel when the mounting bracket is pivoted toward the seating nose member.

7. The mounting bracket of claim 1, wherein the base includes an end wall that extends between the first side wall and the second side wall, and wherein the end wall includes a receiving channel extending through the end wall.

8. The mounting bracket of claim 7, wherein the second clip includes a rear end opposite to the second finger, and wherein the rear end includes a pair of grooves configured to receive lateral supports of a seat connected to the mounting bracket.

9. The mounting bracket of claim 1, wherein the first clip includes a cutout formed at a rear end opposite to the first finger, the cutout being sized to accommodate a rotational element of a seat connected to the mounting bracket.

10. A mounting bracket for connecting an accessory to a bleacher seating system comprising:
a base having a first side wall and a second side wall spaced apart from the first side wall, wherein an interior volume is formed at least partially between the first side wall and the second side wall, and wherein the first side wall includes a first slot and the second side wall includes a second slot; and
a first clip disposed between the first side wall and the second side wall, wherein the first clip includes,
a first finger disposed outside of the interior volume,
a first tab received within the first slot, and
a second tab received within the second slot, and
an adjustment mechanism connected between the base and the first clip,
wherein movement of the adjustment mechanism is configured to permit the first tab to move along the first slot and the second tab to move along the second slot to adjust a position of the first clip relative to the base.

11. The mounting bracket of claim 10, wherein the adjustment mechanism includes a threaded fastener, and wherein the adjustment mechanism is movable in a first rotational direction to move the first clip in a first translational direction relative to the base and in a second rotational direction to move the first clip in a second translational direction relative to the base.

12. The mounting bracket of claim 10, further comprising a second clip connected between the first side wall and the second side wall and spaced apart from the first clip, wherein the second clip includes,
a second finger disposed outside of the interior volume,
a third tab received within a third slot on the first side wall, and
a fourth tab received within a fourth slot on the second side wall.

13. The mounting bracket of claim 12, wherein the first finger extends in a first direction and the second finger extends in a second direction opposite to the first direction.

14. The mounting bracket of claim 12, wherein the second clip includes a protrusion that projects in a direction opposite to the second finger, and wherein the protrusion includes an inclined surface configured to engage a channel of a seating nose member.

15. The mounting bracket of claim 12, wherein the second clip includes a rear end opposite to the second finger, and wherein the rear end includes a pair of grooves.

16. The mounting bracket of claim 10, further comprising an interior plate disposed between the first side wall and the second side wall, wherein the interior plate includes,
a first interior plate tab received within the first slot, and
a second interior plate tab received within the second slot, and
wherein the adjustment mechanism is connected to the interior plate, and
wherein the interior plate remains fixed relative to the base with movement of the adjustment mechanism.

17. The mounting bracket of claim 10, further comprising a receiver disposed at least partially within the interior volume and configured to connect to an accessory.

18. A mounting bracket for connecting a seat to a bleacher seating system, the mounting bracket comprising:
a base having a first side wall, a second side wall spaced apart from the first side wall, and an end wall extending between the first side wall and the second side wall, and wherein the end wall has a substantially L-shape including a vertical portion and an upper section, the end wall including a body channel extending through both the vertical portion and the upper section;
a first clip connected to the base and configured to engage a first channel of a seating nose member, the first clip having a first finger extending in a first direction, the first clip including a cutout formed at a rear of a body of the first clip opposite to the first finger, the cutout being sized to accommodate a rotational element of a seat attachment;
a second clip connected to the base and configured to engage a second channel of the seating nose member, the second clip having a second finger extending in a second direction opposite the first direction, the second clip including a protrusion that projects in a direction opposite to the second finger and is configured to engage the second channel; and
an adjustment mechanism connected to the base and the first clip, the adjustment mechanism comprising a pair of threaded fasteners,
wherein the first clip is moveable relative to the second clip via the adjustment mechanism to secure the base to the seating nose member.

19. The mounting bracket of claim 18, wherein the body channel in the upper section includes a pair of grooves formed at an end of the body channel, the pair of grooves being configured to receive lateral supports of the seat attachment.

20. The mounting bracket of claim 19, wherein the second clip includes a pair of attachment grooves on a rear surface opposite to the second finger, the pair of attachment grooves being configured to receive the lateral supports, and wherein the pair of attachment grooves are aligned with the pair of grooves in the upper section.
